(19) United States
(12) Patent Application Publication
(10) Pub. No.: US 2025/0351140 A1
(43) Pub. Date: Nov. 13, 2025

(54) SIMULTANEOUS PHYSICAL UPLINK CONTROL CHANNEL TRANSMISSIONS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/867,610

(22) PCT Filed: Jul. 11, 2022
(86) PCT No.: PCT/CN2022/104826

§ 371 Date: Nov. 20, 2024

(51) Int. Cl. H04W 72/21; H04B 7/06; H04L 1/1812; H04W 72/12; H04W 72/566

(52) U.S. Cl. CPC H04W 72/21; H04B 7/0626; H04L 1/1812; H04W 72/12; H04W 72/566

(57) ABSTRACT

Various aspects of the present disclosure generally relate to wireless communication. In some aspects, a user equipment (UE) may receive a first indication to transmit first uplink control information (UCI) on a first physical uplink control channel (PUCCH) resource and a second indication to transmit second UCI on a second PUCCH resource. The first PUCCH resource and/or the second PUCCH resource may be a multi-slot PUCCH resource. The UE may receive control signals that schedule a transmission of one or more other UCIs on a set of PUCCH resources in the slot. The UE may perform UCI prioritization for the first PUCCH resource and the set of PUCCH resources in accordance with a set of prioritization rules. The UE may transmit at least the first UCI and the second UCI in the slot based at least in part on the prioritization. Numerous other aspects are described.

### FIELD OF THE DISCLOSURE

Aspects of the present disclosure generally relate to wireless communication and to techniques and apparatuses for simultaneous physical uplink control channel transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first indication to transmit first uplink control information (UCI) on a first physical uplink control channel (PUCCH) resource in a slot and a second indication to transmit second UCI on a second PUCCH resource in the slot, wherein the first UCI comprises hybrid automatic repeat request (HARQ) feedback information associated with a first control resource set pool index value and the second UCI comprises HARQ feedback information associated with a second control resource set pool index value, and wherein at least one of the first PUCCH resource and the second PUCCH resource is a multi-slot PUCCH resource. The method may include receiving control signals that schedule transmissions of one or more other UCIs on a set of PUCCH resources in the slot, the one or more other UCIs comprising channel state information or scheduling request information. The method may include performing UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources. The method may include transmitting at least the first UCI and the second UCI in the slot based at least in part on the prioritization.

Some aspects described herein relate to a method of wireless communication performed by a UE. The method may include receiving a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value. The method may include receiving a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource. The method may include performing first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources. The method may include performing second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources. The method may include transmitting at least a subset of the first plurality of UCIs on the first one or more non-overlapping PUCCH resources and at least a subset of the second plurality of UCIs on the second one or more non-overlapping PUCCH resources.

Some aspects described herein relate to an apparatus for wireless communication performed by a UE. The apparatus may include a memory and one or more processors, coupled to the memory. The one or more processors may be configured to receive a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource. The one or more processors may be configured to receive control signals that schedule transmissions of one or more other UCIs on a set of PUCCH resources in the slot, the one or more other UCIs comprising channel state information or scheduling request information. The one or more processors may be configured to perform UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources. The one or more processors may be configured to transmit at least the first UCI and the second UCI in the slot based at least in part on the prioritization.

Some aspects described herein relate to an apparatus for wireless communication performed by a UE. The apparatus may include a memory and one or more processors, coupled to the memory. The one or more processors may be configured to receive a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value. The one or more processors may be configured to receive a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource. The one or more processors may be configured to perform first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources. The one or more processors may be configured to perform second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources. The one or more processors may be configured to transmit at least a subset of the first plurality of UCIs on the first one or more non-overlapping PUCCH resources and at least a subset of the second plurality of UCIs on the second one or more non-overlapping PUCCH resources.

Some aspects described herein relate to a non-transitory computer-readable medium that stores a set of instructions for wireless communication by a UE. The set of instructions, when executed by one or more processors of the UE, may cause the UE to receive a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource. The set of instructions, when executed by one or more processors of the UE, may cause the UE to receive control signals that schedule transmissions of one or more other UCIs on a set of PUCCH resources in the slot, the one or more other UCIs comprising channel state information or scheduling request information. The set of instructions, when executed by one or more processors of the UE, may cause the UE to perform UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources. The set of instructions, when executed by one or more processors of the UE, may cause the UE to transmit at least the first UCI and the second UCI in the slot based at least in part on the prioritization.

Some aspects described herein relate to a non-transitory computer-readable medium that stores a set of instructions for wireless communication by a UE. The set of instructions, when executed by one or more processors of the UE, may cause the UE to receive a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value. The set of instructions, when executed by one or more processors of the UE, may cause the UE to receive a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource. The set of instructions, when executed by one or more processors of the UE, may cause the UE to perform first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources. The set of instructions, when executed by one or more processors of the UE, may cause the UE to perform second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources. The set of instructions, when executed by one or more processors of the UE, may cause the UE to transmit at least a subset of the first plurality of UCIs on the first one or more non-overlapping PUCCH resources and at least a subset of the second plurality of UCIs on the second one or more non-overlapping PUCCH resources.

Some aspects described herein relate to an apparatus for wireless communication. The apparatus may include means for receiving a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource. The apparatus may include means for receiving control signals that schedule transmissions of one or more other UCIs on a set of PUCCH resources in the slot, the one or more other UCIs comprising channel state information or scheduling request information. The apparatus may include means for performing UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources. The apparatus may include means for transmitting at least the first UCI and the second UCI in the slot based at least in part on the prioritization.

Some aspects described herein relate to an apparatus for wireless communication. The apparatus may include means for receiving a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value. The apparatus may include means for receiving a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource. The apparatus may include means for performing first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources. The apparatus may include means for performing second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources. The apparatus may include means for transmitting at least a subset of the first plurality of UCIs on the first one or more non-overlapping PUCCH resources and at least a subset of the second plurality of UCIs on the second one or more non-overlapping PUCCH resources.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIGS. 5A-5C are diagrams illustrating examples of uplink control information (UCI) multiplexing and prioritization, in accordance with the present disclosure.

FIG. 6 is a diagram illustrating an example of UCI multiplexing and prioritization, in accordance with the present disclosure.

FIG. 7 is a diagram illustrating an example of simultaneous physical uplink control channel (PUCCH) transmissions, in accordance with the present disclosure.

FIGS. 8A-8C are diagrams illustrating examples of resolving overlapping PUCCH transmissions, in accordance with the present disclosure.

FIG. 9 is a diagram illustrating an example of simultaneous PUCCH transmissions, in accordance with the present disclosure.

FIGS. 10A-10B are diagrams illustrating an example of resolving overlapping PUCCH transmissions, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

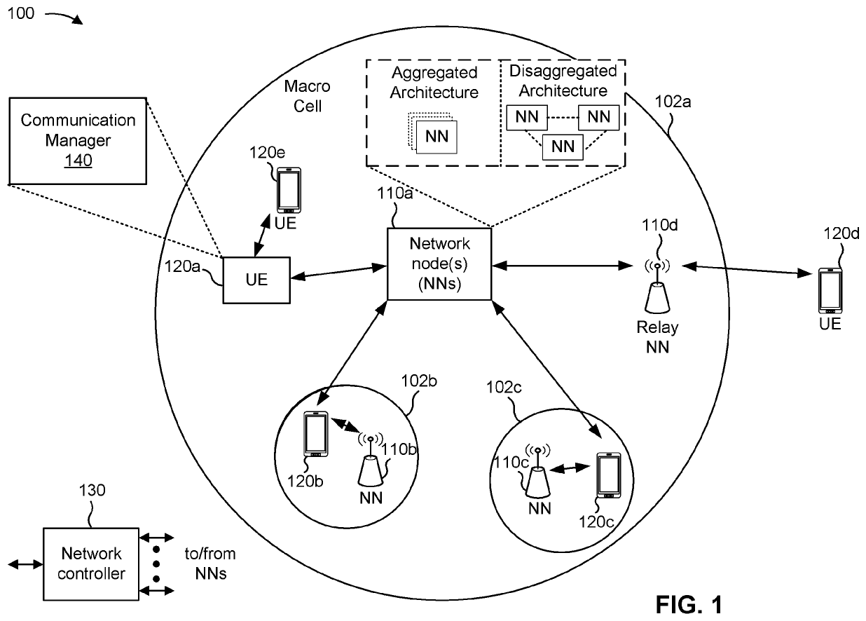

FIG. 1 is a diagram illustrating an example of a wireless network 100, in accordance with the present disclosure. The wireless network 100 may be or may include elements of a 5G (e.g., NR) network and/or a 4G (e.g., Long Tenn Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first indication to transmit first uplink control information (UCI) on a first physical uplink control channel (PUCCH) resource in a slot and a second indication to transmit second UCI on a second PUCCH resource in the slot, wherein the first UCI comprises hybrid automatic repeat request (HARQ) feedback information associated with a first control resource set pool index value and the second UCI comprises HARQ feedback information associated with a second control resource set pool index value, and wherein at least one of the first PUCCH resource and the second PUCCH resource is a multi-slot PUCCH resource; receive control signals that schedule transmissions of one or more other UCIs on a set of PUCCH resources in the slot, the one or more other UCIs comprising channel state information or scheduling request information; perform UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources; and transmit at least the first UCI and the second UCI in the slot based at least in part on the prioritization. Additionally, or alternatively, the communication manager 140 may perform one or more other operations described herein.

In some aspects, the communication manager 140 may receive a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value; receive a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource; perform first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources; perform second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources; and transmit at least a subset of the first plurality of UCIs on the first one or more non-overlapping PUCCH resources and at least a subset of the second plurality of UCIs on the second one or more non-overlapping PUCCH resources. Additionally, or alternatively, the communication manager 140 may perform one or more other operations described herein.

As indicated above, FIG. 1 is provided as an example. Other examples may differ from what is described with regard to FIG. 1.

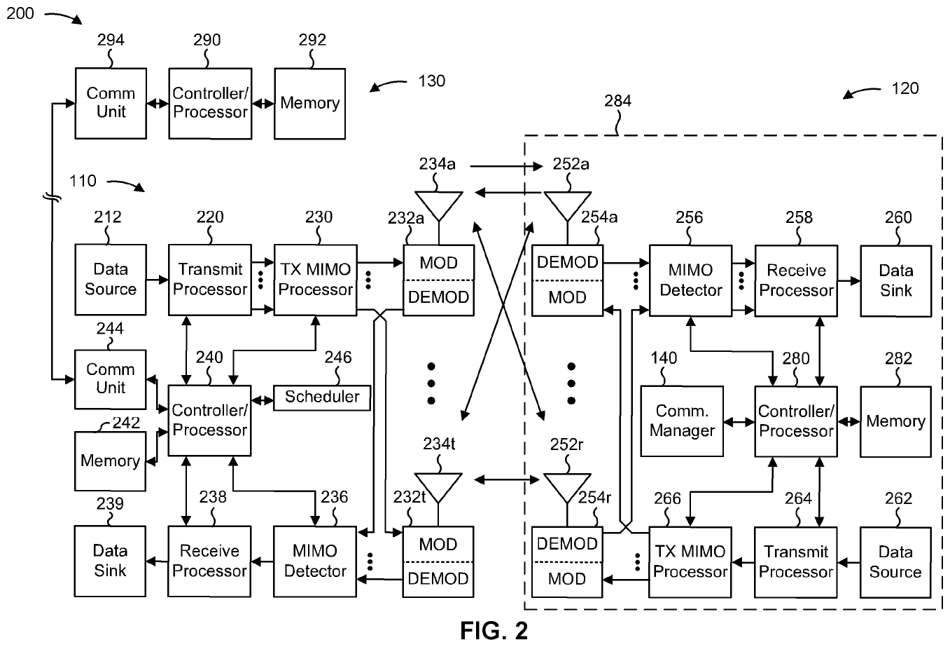

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

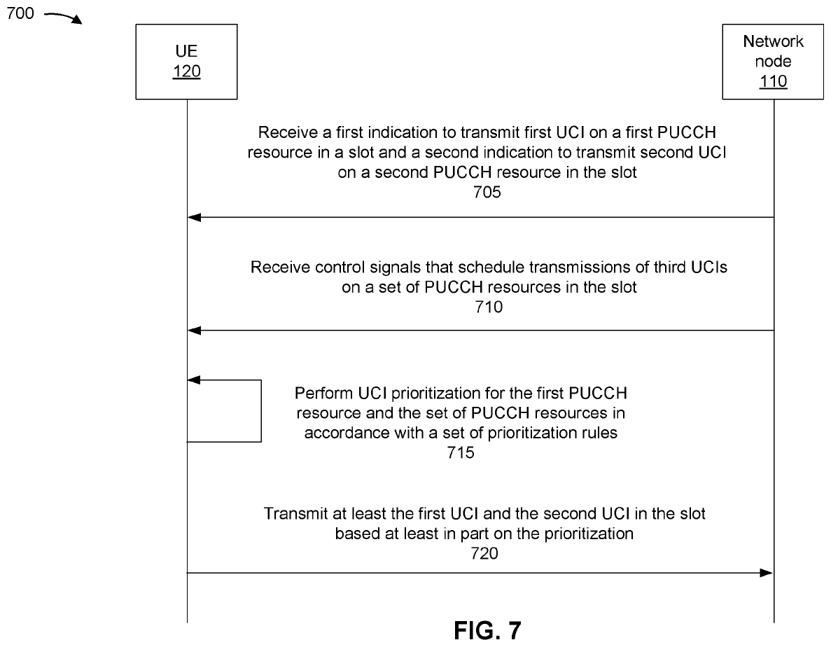

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

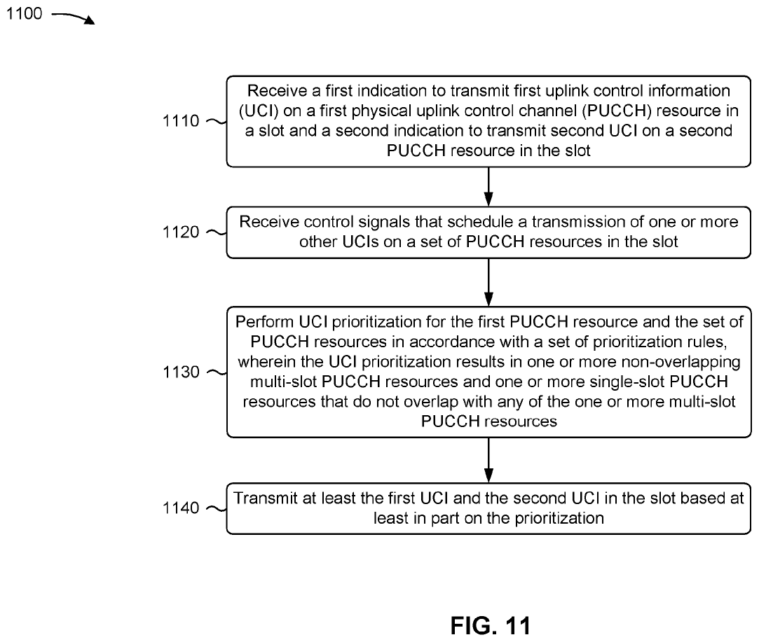

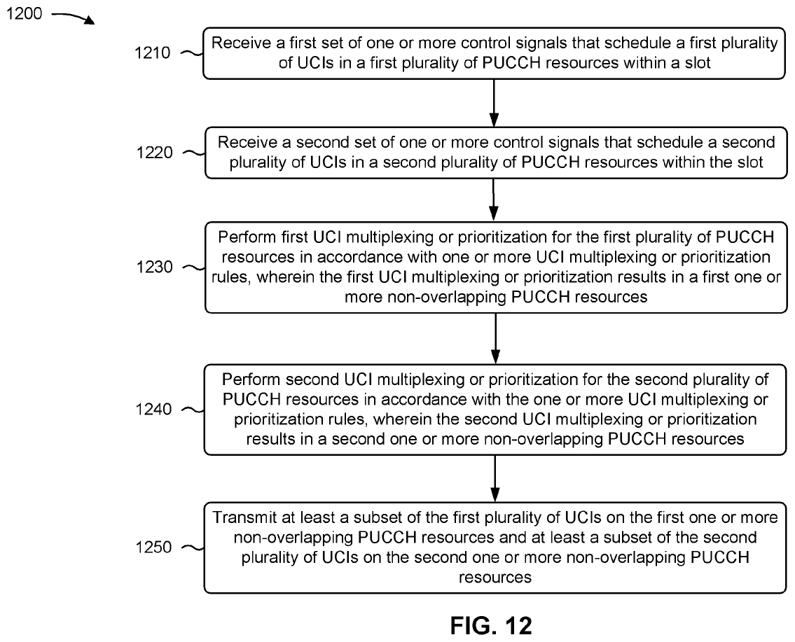

The controller/processor 240 of the network node 110, the controller/processor 280 of the UE 120, and/or any other component(s) of FIG. 2 may perform one or more techniques associated with simultaneous PUCCH transmissions, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource; means for receiving control signals that schedule transmissions of one or more other UCIs on a set of PUCCH resources in the slot, the one or more other UCIs comprising channel state information or scheduling request information; means for performing UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources; and/or means for transmitting at least the first UCI and the second UCI in the slot based at least in part on the prioritization. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for receiving a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value; means for receiving a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource; means for performing first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources; means for performing second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources; and/or means for transmitting at least a subset of the first plurality of UCIs on the first one or more non-overlapping PUCCH resources and at least a subset of the second plurality of UCIs on the second one or more non-overlapping PUCCH resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, abase station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

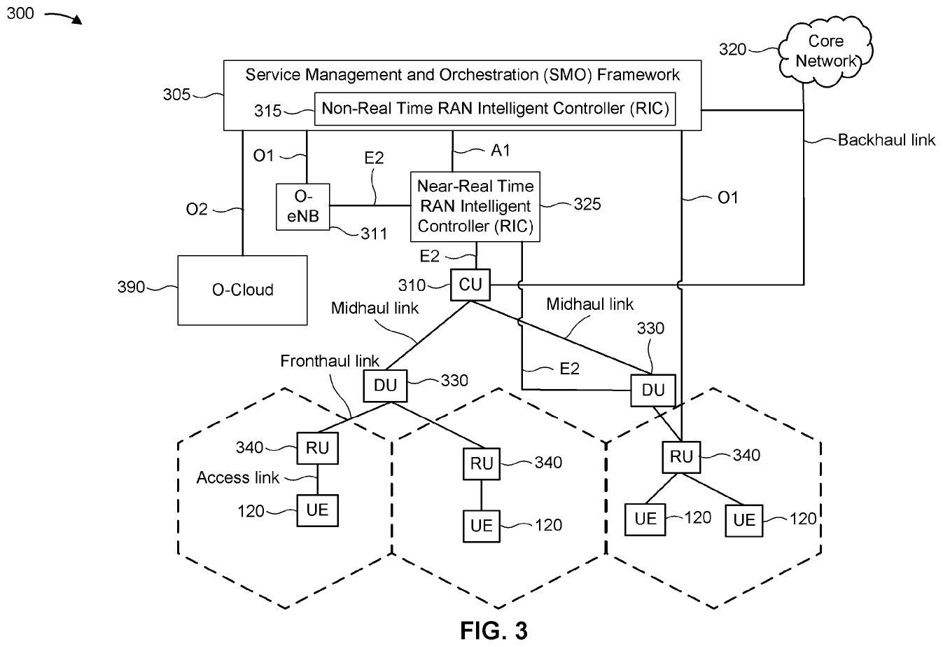

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

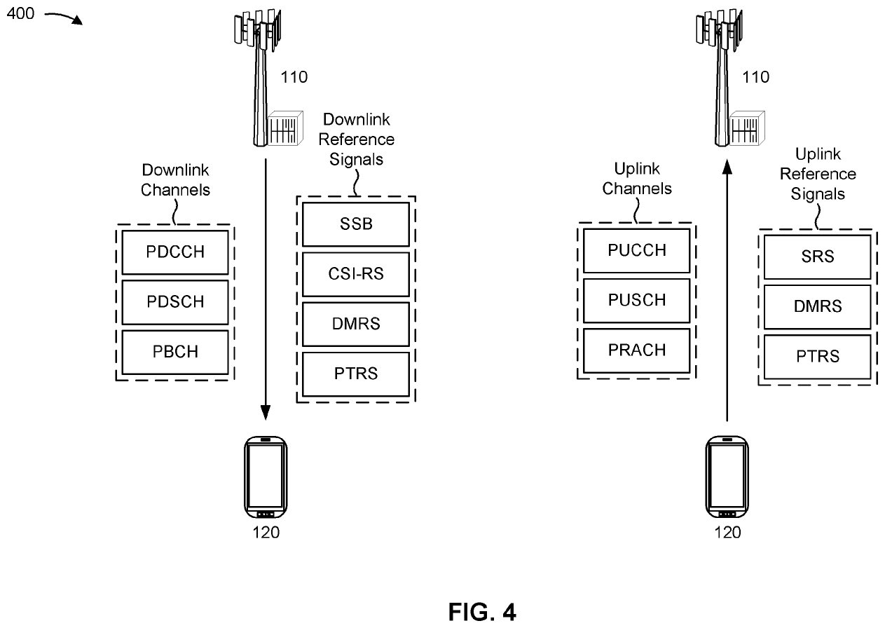

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

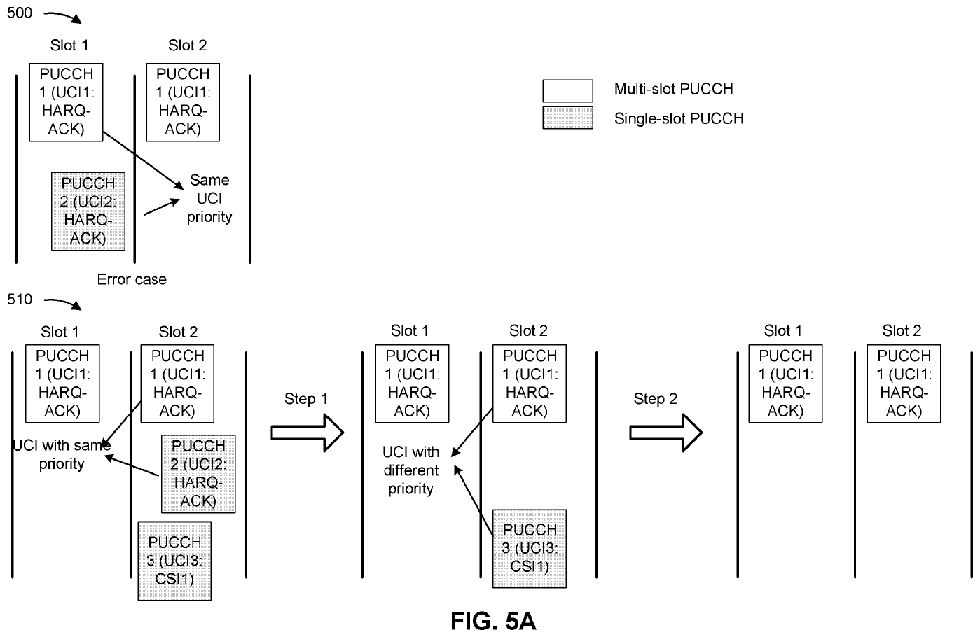

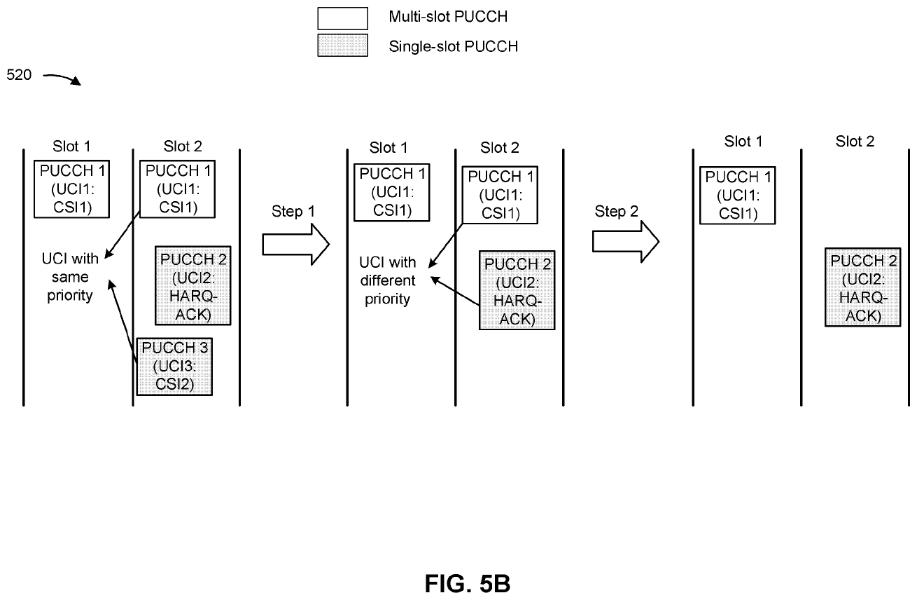

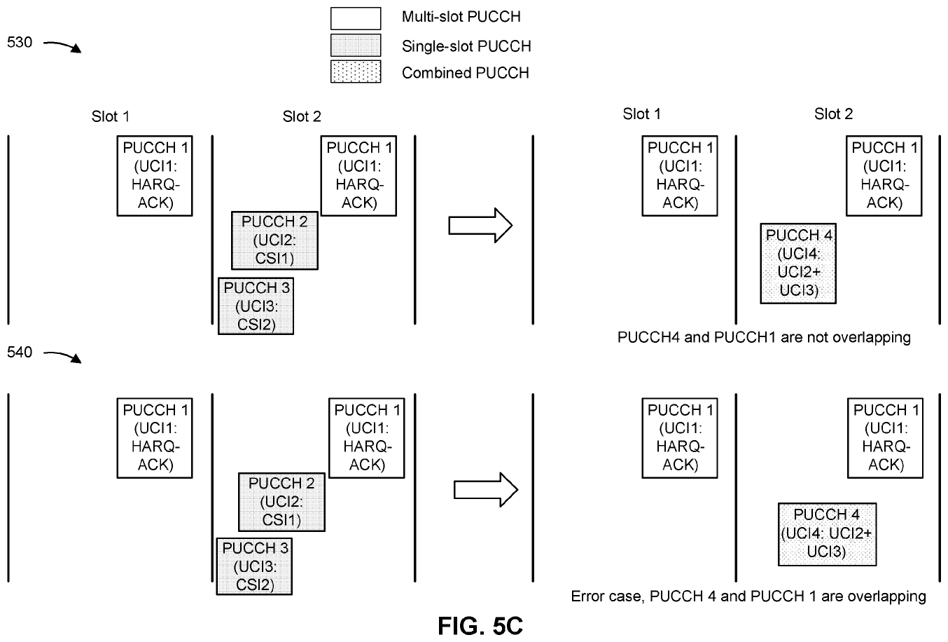

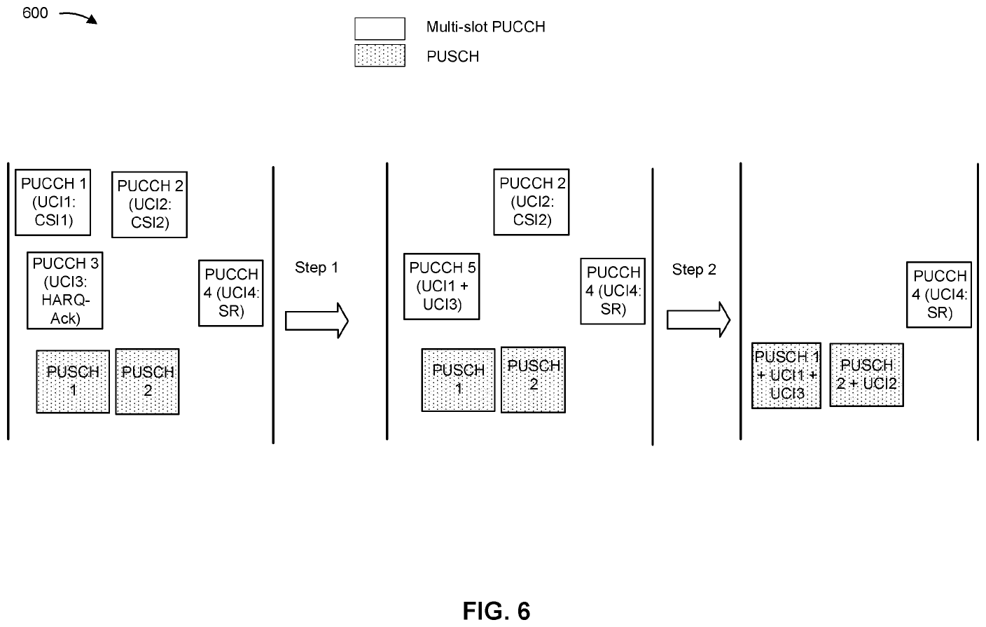

FIGS. 5A-5C are diagrams illustrating examples 500, 510, 520, 530, and 540 of UCI multiplexing and prioritization, in accordance with the present disclosure. In some cases, PUCCH resources may overlap in a slot, and at least one of the PUCCH resources may be a multi-slot PUCCH resource (e.g., a PUCCH resource that spans multiple slots). In some cases, the UE 120 may initiate a UCI multiplexing or prioritization procedure to resolve the overlapping PUCCH resources. Revolving the overlapping PUCCH resources may include selecting a subset (e.g., one or more, but fewer than all) of the PUCCH resources to be transmitted in the slot and/or multiplexing the overlapping PUCCH resources to be transmitted in the slot. This may result in non-overlapping PUCCH resources in the slot. For resultant non-overlapping multi-slot PUCCH resources, each multi-slot PUCCH resource may not overlap with any other PUCCH resources. For the resultant single-slot PUCCH resources, each single-slot PUCCH resource may not overlap with any of the resultant multi-slot PUCCH resources. However, a resultant single-slot PUCCH resource may (or may not) overlap with another single-slot PUCCH resource. In some cases, if the resultant single-slot PUCCH resource overlaps with another single-slot PUCCH resource, the UE 120 may resolve the overlapping across the multiple single-slot PUCCH resources as described in the example of FIG. 6.

As described herein, the UE 120 may be configured to resolve an overlap between two or more multi-slot PUCCH resources and/or between a multi-slot PUCCH resource and a single-slot PUCCH resource. For example, the UE 120 may resolve two or more overlapping PUCCH resources in a slot within the same PUCCH group, where at least one of the PUCCH resources is a multi-slot PUCCH resource. In a first example step (step 1), the UE 120 may resolve the overlapping for the PUCCH resources having the same UCI priority. In this case, the UE 120 may transmit on the PUCCH resource having an earlier start time. In a second example step (step 2), the UE 120 may resolve the overlapping for the PUCCH resources having different UCI priorities. In this case, the UE 120 may transmit on the PUCCH resource with the higher (or highest) UCI priority in the overlapping slot. In some cases, the priority may be defined as follows (from highest priority to lowest priority): hybrid automatic repeat request (HARQ) acknowledgement (ACK) (HARQ-ACK), scheduling request (SR), channel state information (CSI) with higher priority, and CSI with lower priority. In some cases, in the overlapping slot, the de-prioritized UCI (e.g., the UCI with a lower priority) may be dropped without any postponing of the UCI transmission. However, there may be no impact on the transmission of the de-prioritized UCI in the remaining non-overlapping slots. In some cases, the UE 120 is not expected to have a group of overlapping single-slot PUCCH resources that do not overlap with multi-slot PUCCH resources to be multiplexed into a single-slot PUCCH resource that overlaps with the multi-slot PUCCH resource.

As shown in the example 500 (in FIG. 5A), PUCCH1 may be associated with UCI1 that includes a HARQ-ACK. PUCCH1 may be a multi-slot PUCCH resource. For example, the transmission for PUCCH1 may span slot 1 and slot 2. PUCCH2 may be associated with UCI2 that includes a HARQ-ACK. PUCCH2 may be a single-slot PUCCH resource. Since PUCCH1 and PUCCH2 have the same priority, this may be considered an error case since the UE 120 may not know which PUCCH is to be transmitted or dropped.

As shown in the example 510, PUCCH1 may be associated with UCI1 that includes a HARQ-ACK. PUCCH1 may be a multi-slot PUCCH resource. PUCCH2 may be associated with UCI2 that includes a HARQ-ACK. PUCCH2 may be a single-slot PUCCH resource. PUCCH1 and PUCCH2 may have the same priority. PUCCH3 may be associated with UCI3 that includes CSI (CSI1). PUCCH3 may be a single-slot PUCCH resource. In step 1, the UE 120 may resolve the overlap between PUCCH1 and PUCCH2. Since PUCCH1 starts in an earlier slot than PUCCH2, PUCCH2 may be dropped in slot 2. In step 2, the UE 120 may resolve the overlap between PUCCH1 and PUCCH3. Since UCI1 has a higher priority than UCI3, PUCCH3 may be dropped in slot 2.

As shown in the example 520 (in FIG. 5B), PUCCH1 may be associated with UCI1 that includes a CSI (CSI1). PUCCH1 may be a multi-slot PUCCH resource. PUCCH 2 may be associated with a UCI2 that includes a HARQ-ACK. PUCCH2 may be a single-slot PUCCH resource. PUCCH 3 may be associated with a UCI3 that includes a CSI (CSI2). PUCCH3 may be a single-slot PUCCH resource. PUCCH1 and PUCCH3 may have the same priority. In step 1, the UE 120 may resolve collision between PUCCH1 and PUCCH3. Since PUCCH1 starts in an earlier slot than PUCCH3, PUCCH3 may be dropped in slot 2. In step 2, the UE 120 may resolve collision between PUCCH1 and PUCCH2. Since UCI2 has a higher priority than UCI1, PUCCH1 may be dropped in slot 2. However, PUCCH1 may still be transmitted in slot 1.

As shown in the example 530 (in FIG. 5C), PUCCH1 may be associated with UCI1 that includes a HARQ-ACK. PUCCH1 may be a multi-slot PUCCH resource. PUCCH 2 may be associated with a UCI2 that includes a CSI (CSI2). PUCCH2 may be a single-slot PUCCH resource. PUCCH 3 may be associated with a UCI3 that includes a CSI (CSI2). PUCCH3 may be a single-slot PUCCH resource. PUCCH2 and PUCCH3 may overlap in the slot 2. In this case, the UE 120 may resolve the overlap between PUCCH2 and PUCCH3 by multiplexing PUCCH2 and PUCCH3 to generate PUCCH4 that includes UCI2 and UCI3. This is possible because the resultant PUCCH4 after multiplexing PUCCH2 and PUCCH3 does not overlap with PUCCH1.

As shown in the example 540, PUCCH1 may be associated with UCI1 that includes a HARQ-ACK. PUCCH1 may be a multi-slot PUCCH resource. PUCCH 2 may be associated with a UCI2 that includes a CSI (CSI2). PUCCH2 may be a single-slot PUCCH resource. PUCCH 3 may be associated with a UCI3 that includes a CSI (CSI2). PUCCH3 may be a single-slot PUCCH resource. PUCCH2 and PUCCH3 may overlap in the slot 2. In this case, the UE 120 may not be able to resolve the overlap between PUCCH2 and PUCCH3 by multiplexing PUCCH2 and PUCCH3 since the resultant PUCCH4 after multiplexing PUCCH2 and PUCCH3 overlaps with PUCCH1. Thus, this may be considered an error case since the UE 120 may not be able to determine which PUCCH is to be transmitted or dropped.

As indicated above, FIGS. 5A-5C are provided as examples. Other examples may differ from what is described with regard to FIGS. 5A-5C.

FIG. 6 is a diagram illustrating an example 600 of UCI multiplexing and prioritization, in accordance with the present disclosure. In some cases, when a PUCCH resource that includes HARQ-ACK or CSI overlaps with a PUSCH, the UCI associated with the PUCCH resource may be multiplexed on the PUSCH. In a first example step (step 1), the UE 120 may resolve the overlapping PUCCH resources for UCI multiplexing. This may be performed as shown in connection with the examples 500-540, and may result in non-overlapping PUCCH resources. In a second example step (step 2), the one or more UCIs from step 1 may be multiplexed with the PUSCH based at least in part on the corresponding PUCCH resource overlapping with the PUSCH. In this case, the PUCCH may not be separately transmitted. In some cases, a beta offset that is signaled in an uplink grant (e.g., using DCI 0_1/0_2) or configured (e.g., using an RRC parameter) may be used to control a rate matching behavior (e.g., how to multiplex the PUCCH on the PUSCH), and may indicate the number of resources that the UCI payload can occupy on the PUSCH. The overlapping PUCCH resource and PUSCH resource may be in the same component carrier (CC) or in different CCs.

As shown in the example 600, PUCCH1 may be associated with UCI1 that includes a CSI (CSI1). PUCCH2 may be associated with UCI2 that includes a CSI (CSI2). PUCCH3 may be associated with UCI3 that includes a HARQ-ACK. PUCCH4 may be associated with UCI4 that includes an SR. PUCCH1, PUCCH2, PUCCH3, and PUCCH4 may be included in a slot. The slot may also include PUSCH1 and PUSCH2. In a first example step (step 1), the UE 120 may resolve an overlap between PUCCH1 and PUCCH3 since PUCCH1 and PUCCH3 are overlapping PUCCH resources. The UE 120 may resolve the overlap by multiplexing PUCCH1 and PUCCH3 to generate a PUCCH5 that includes UCI1 and UCI3. In a second example step (step 2), the UE 120 may resolve an overlap between the PUCCH resources and the PUSCH resources. For example, PUCCH5 may be multiplexed with PUSCH1 since PUCCH5 overlaps with PUSCH1. Thus, UCI1 and UCI3 (associated with PUCCH5) may be transmitted with PUSCH1. Similarly, PUCCH2 may be multiplexed with PUSCH2 since PUCCH2 overlaps with PUSCH2. Thus, UCI2 may be transmitted with PUSCH2.

In some cases, multiple PUCCH transmissions in a single CC may be performed for multi-DCI based multi-TRP, such as when separate ACK/NACK feedback is configured (e.g., when “ackNackFeedbackMode=separate” is configured). Previous UCI multiplexing and prioritization rules for overlapping PUCCH associated with multi-slot PUCCH resources do not account for simultaneous PUCCH transmissions. For UCIs having the same priority but different control resource set (CORESET) pool index (CORESETPoolIndex) values, prioritization may not be needed since the UCIs can be simultaneously transmitted. However, the previous UCI multiplexing and prioritization rules do not specify which UCIs are to be multiplexed or prioritized for simultaneous PUCCH transmissions associated with multi-slot PUCCH resources. This may lead to an increase in error cases, such as missed UCI transmissions or a transmission of low priority UCI over high priority UCI, when simultaneous PUCCH transmissions are scheduled to occur in the multi-slot PUCCH resources.

Techniques and apparatuses are described herein for simultaneous PUCCH transmissions. In some aspects, a UE may receive a first indication to transmit first UCI on a first PUCCH resource in a slot and a second indication to transmit second UCI on a second PUCCH resource in the slot. The first UCI may include HARQ feedback information associated with a first CORESET pool index value and the second UCI may include HARQ feedback information associated with a second CORESET pool index value, and at least one of the first PUCCH resource and the second PUCCH resource may be a multi-slot PUCCH resource. The UE may receive control signals that schedule transmissions of one or more other UCIs on a set of PUCCH resources in the slot. The one or more other UCIs may include CSI or SR information. The UE may perform UCI prioritization for the first PUCCH resource and the set of PUCCH resources in accordance with a set of prioritization rules. The UCI prioritization may result in one or more non-overlapping multi-slot PUCCH resources and one or more single-slot PUCCH resources that do not overlap with any of the one or more multi-slot PUCCH resources. The UE may transmit at least the first UCI and the second UCI in the slot based at least in part on the prioritization.

As described herein, the previous UCI multiplexing and prioritization rules for overlapping PUCCH associated with multi-slot PUCCH resources do not account for simultaneous PUCCH transmissions. For example, the previous UCI multiplexing and prioritization rules do not specify which UCIs are to be multiplexed or prioritized for simultaneous PUCCH transmissions associated with multi-slot PUCCH resources. This may lead to an increase in error cases, such as missed UCI transmissions or a transmission of low priority UCI over high priority UCI, when simultaneous PUCCH transmissions are scheduled to occur in the multi-slot PUCCH resources. Using the techniques and apparatuses described herein, the UE may be configured with a set of UCI multiplexing and prioritization rules that enable simultaneous PUCCH transmissions for overlapping PUCCH resources associated with multi-slot PUCCH resources. The UE may perform simultaneous PUCCH transmissions in accordance with the set of UCI multiplexing and prioritization rules, thereby reducing the number of error cases and improving the reliability of the transmissions.

As indicated above, FIG. 6 is provided as an example. Other examples may differ from what is described with regard to FIG. 6.

FIG. 7 is a diagram illustrating an example 700 of simultaneous PUCCH transmissions, in accordance with the present disclosure. The UE 120 may communicate with the network node 110. In the example 700, PUCCH resources with CSI or SR information may not be explicitly associated with a CORESET pool index value. Thus, simultaneous PUCCH transmissions may only be possible if each of the PUCCH resources carries HARQ-ACK associated with a corresponding CORESET pool index value.

As shown by reference number 705, the UE 120 may receive a first indication to transmit first UCI on a first PUCCH resource (PUCCH 1) in a slot and a second indication to transmit second UCI on a second PUCCH resource (PUCCH2) in the slot. For example, the network node 110 may transmit, and the UE 120 may receive, the first indication to transmit the first UCI on the first PUCCH resource in the slot and the second indication to transmit the second UCI on the second PUCCH resource in the slot. The first UCI may include HARQ feedback information associated with a first CORESET pool index value (e.g., CORESET pool index value 0) and the second UCI may include HARQ feedback information associated with a second CORESET pool index value (e.g., CORESET pool index value 1). At least one of the first PUCCH resource and the second PUCCH resource may be a multi-slot PUCCH resource.

As shown by reference number 710, the UE 120 may receive control signals that schedule transmissions of one or more other UCIs on a set of PUCCH resources in the slot. For example, the network node 110 may transmit, and the UE 120 may receive, the control signals that schedule the transmission of the one or more other UCIs on the set of PUCCH resources in the slot. The one or more other UCIs may include CSI or SR information.

As shown by reference number 715, the UE 120 may perform UCI prioritization for the first PUCCH resource (PUCCH1) and the set of PUCCH resources (e.g., the resources for transmitting the one or more other UCIs) in accordance with a set of UCI multiplexing and prioritization rules. The set of UCI multiplexing and prioritization rules may include one or more rules for performing simultaneous PUCCH transmissions associated with overlapping PUCCH and multi-slot PUCCH resources. This is in contrast to the previous UCI multiplexing and prioritization rules, which do not include one or more rules for performing simultaneous PUCCH transmissions associated with overlapping PUCCH and multi-slot PUCCH resources. The UCI prioritization, performed in accordance with the set of UCI multiplexing and prioritization rules, may result in one or more non-overlapping multi-slot PUCCH resources and one or more single-slot PUCCH resources that do not overlap with any of the one or more multi-slot PUCCH resources.

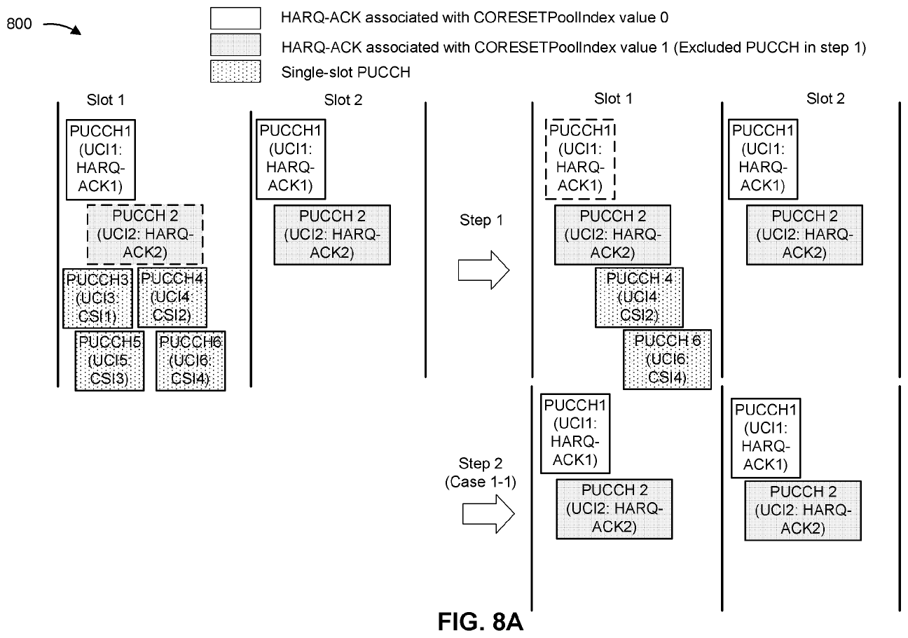

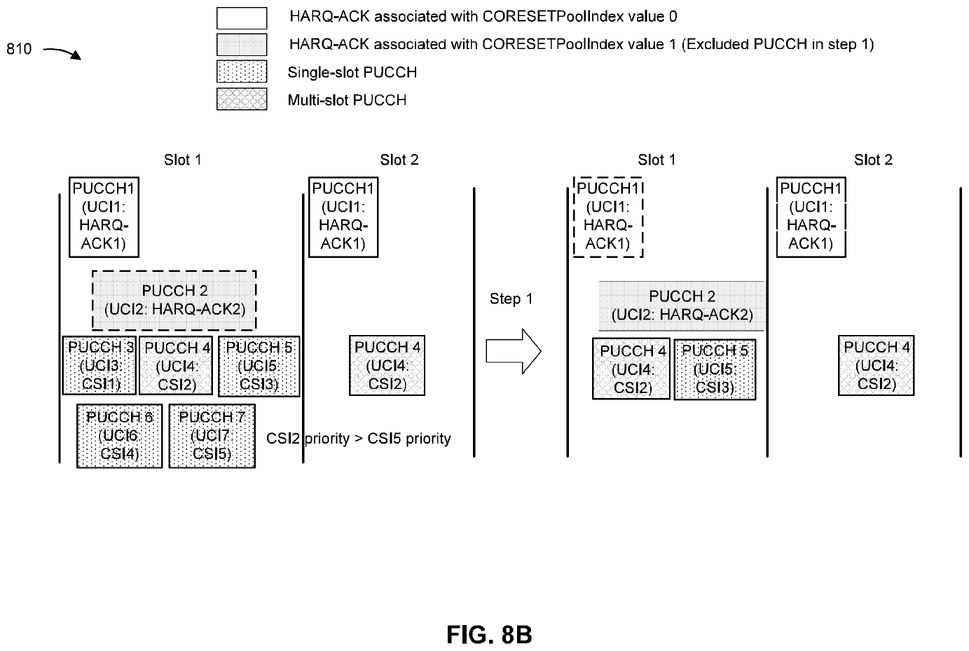

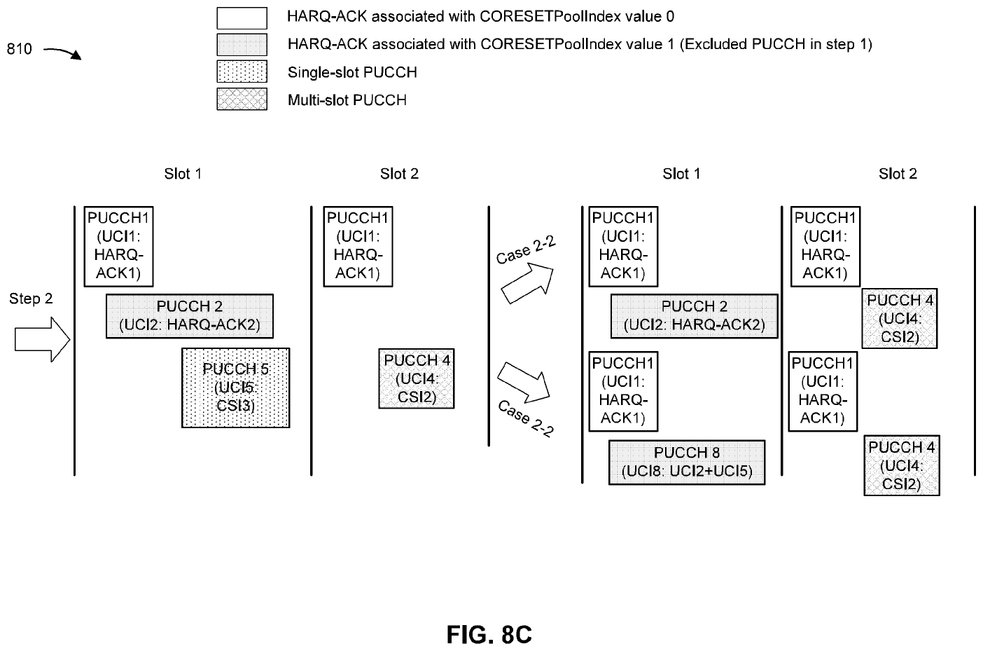

In some aspects, the UE 120 may be configured for simultaneous PUCCH transmissions based at least in part on two (or more) CORESET pool index values being configured for the UE 120, and based at least in part on separate HARQ feedback modes being configured (e.g., “ackNackFeedbackMode=separate”) for the UE 120. In a first example step (shown as step 1), when two PUCCH resources (PUCCH1 and PUCCH2) carrying HARQ-ACK associated with two corresponding CORESET pool index values are scheduled in a slot (slot 1 and/or slot 2), and at least one of the two PUCCH resources is a multi-slot PUCCH resource, the UE 120 may first exclude the PUCCH carrying the HARQ-ACK associated with a fixed CORESET pool index value and may resolve the overlapping for the multi-slot PUCCH resources among the remaining PUCCH resources. In some aspects, if one of the two PUCCH resources (PUCCH2) is a single-slot PUCCH, and one of the two PUCCH resources (PUCCH1) is a multi-slot PUCCH resource, the fixed CORESET pool index value may be associated with the single-slot PUCCH resource (e.g., PUCCH2). Thus, the second PUCCH resource (PUCCH2) may be the excluded PUCCH resource (e.g., excluded from the set of UCI multiplexing and prioritization rules). In some aspects, if both PUCCH resources carrying HARQ-ACK are multi-slot PUCCH resources (e.g., both PUCCH1 and PUCCH2 are multi-slot PUCCH resources), the UE 120 may determine the fixed CORESET pool index value based at least in part on a configuration of the UE 120 and/or based at least in part on information received by the UE 120. In some aspects, the UE 120 may use information associated with the one or more other PUCCH resource(s) for CSI or SR and the PUCCH resource (PUCCH1) for HARQ-ACK associated with the other CORESET pool index value (e.g., value 0), and may apply the previous UCI multiplexing and prioritization rules for the multi-slot PUCCH resources. This may result in one or more non-overlapping multi-slot PUCCH resources, with one of the non-overlapping multi-slot PUCCH resources being the multi-slot PUCCH resource (PUCCH1) with HARQ-ACK associated with the other CORESET pool index value, and one or more single-slot PUCCH resources with CSI or SR that do not overlap with any of the multi-slot PUCCH resources. Additional details regarding these features are described in connection with FIGS. 8A-8B.

In some aspects, in a second example step (step 2, case 1), if the excluded PUCCH resource (PUCCH2) is a multi-slot PUCCH resource, and the excluded PUCCH resource overlaps with at least one of the resultant PUCCH resources from step 1 other than the multi-slot PUCCH resource (PUCCH1) with HARQ-ACK associated with the other CORESET pool index value (e.g., 0), the UE 120 may drop one or more resultant PUCCH resources (single-slot and/or multi-slot) that overlap with the excluded PUCCH resource (PUCCH2) other than the multi-slot PUCCH (PUCCH1) with HARQ-ACK associated with the other CORESET pool index value. In a first example for step 2 (step 2, case 1-1), if the one or more single-slot PUCCH resources from step 1 that do not overlap with the excluded PUCCH resource (PUCCH2) do not overlap with each other, the UE 120 may transmit the excluded PUCCH resource (PUCCH2) with HARQ-ACK associated with the fixed CORESET pool index value, the multi-slot PUCCH (PUCCH1) with HARQ-ACK associated with the other CORESET pool index value (e.g., 0), and the other PUCCH resources from step 1 that do not overlap with the excluded PUCCH resource (PUCCH2). In a second example for step 2 (step 2, case 1-2), if there is overlapping among the one or more single-slot PUCCH resources from step 1 that do not overlap with the excluded PUCCH resource (PUCCH2), the UE 120 may resolve the overlapping among the one or more single-slot PUCCH resources using the existing UCI multiplexing and prioritization rules (e.g., in Release 15 of the 3GPP Specifications). In this case, the UE 120 may transmit the excluded PUCCH resource (PUCCH2) with HARQ-ACK associated with the fixed CORESET pool index value, the multi-slot PUCCH (PUCCH1) with HARQ-ACK associated with the other CORESET pool index value (e.g., 0), the multi-slot PUCCH resources from step 1 that do not overlap with the excluded PUCCH resource (PUCCH2), and the single-slot PUCCH resources after multiplexing the one or more overlapping single-slot PUCCH resources. In the second example for step 2, the UE 120 does not expect the one or more single-slot PUCCH resources that do not overlap with any of the excluded PUCCH resource, the multi-slot PUCCH (PUCCH1) with HARQ-ACK associated with the other CORESET pool index value and the one or more multi-slot PUCCH resources from step 1 that do not overlap with the excluded PUCCH resource (PUCCH2) to be multiplexed into a single-slot PUCCH that may overlap with any of the excluded PUCCH resource, the multi-slot PUCCH (PUCCH1) with HARQ-ACK associated with the other CORESET pool index value and the one or more multi-slot PUCCH resources from step 1 that do not overlap with the excluded PUCCH resource (PUCCH2). Additional details regarding these features are described in connection with FIG. 8A.

In some aspects, in an example alternate step 2 (step 2, case 2), if the excluded PUCCH resource (PUCCH2) is single-slot PUCCH, and the excluded PUCCH resource overlaps with at least one of the resultant multi-slot PUCCH resources from step 1 other than the multi-slot PUCCH (PUCCH1) with HARQ-ACK associated with the other CORESET pool index value (e.g., 0), the UE 120 may select the multi-slot PUCCH resources that overlap with the excluded PUCCH resource (PUCCH2), other than the multi-slot PUCCH (PUCCH1) with HARQ-ACK associated with the other CORESET pool index value, and may drop the selected multi-slot PUCCH resources. In a first example for alternate step 2 (step 2, case 2-1), if the excluded PUCCH resource (PUCCH2) and the single-slot PUCCH resources from step 1 do not overlap with each other, the UE 120 may transmit the excluded PUCCH resource (PUCCH2) with HARQ-ACK associated with the fixed CORESET pool index value, the multi-slot PUCCH (PUCCH1) with HARQ-ACK associated with the other CORESET pool index value (e.g., 0), and the other multi-slot PUCCH resources from step 1 that do not overlap with the excluded PUCCH resource and the other single-slot PUCCH resources from step 1. In a second example for alternate step 2 (step 2, case 2-2), if there is overlapping among the excluded PUCCH resource (PUCCH2) and the single-slot PUCCH resources from step 1, the UE 120 may use the existing UCI multiplexing and prioritization rules in Rel.15 to perform multiplexing and/or prioritization for the excluded PUCCH resource (PUCCH2) and the single-slot PUCCH resources from step 1. In this case, the UE 120 may transmit the multi-slot PUCCH (PUCCH 1) with HARQ-ACK associated with the other CORESET pool index value, the other multi-slot PUCCH resources from step 1 that do not overlap with the excluded PUCCH resource (PUCCH2), and the single-slot PUCCH resources after multiplexing the excluded PUCCH resource (PUCCH2) and the single-slot PUCCH resources from step 1. Additional details regarding these features are described in connection with FIG. 8C.

As shown by reference number 720, the UE 120 may transmit at least the first UCI and the second UCI in the slot based at least in part on the prioritization. In some aspects, as described above in connection with the first example for step 2 (step 2, case 1-1), the UE 120 may transmit the excluded PUCCH resource (PUCCH2) with HARQ-ACK associated with the fixed CORESET pool index value, the multi-slot PUCCH (PUCCH1) with HARQ-ACK associated with the other CORESET pool index value (e.g., 0), and the other PUCCH resources from step 1 that do not overlap with the excluded PUCCH resource (PUCCH2). In some aspects, as described above in connection with the second example for step 2 (step 2, case 1-2), the UE 120 may transmit the excluded PUCCH resource (PUCCH2) with HARQ-ACK associated with the fixed CORESET pool index value, the multi-slot PUCCH (PUCCH1) with HARQ-ACK associated with the other CORESET pool index value, the multi-slot PUCCH resources from step 1 that do not overlap with the excluded PUCCH resource (PUCCH2), and the single-slot PUCCH resources after multiplexing the one or more overlapping single-slot PUCCH resources. In some aspects, as described above in connection with the first example for alternate step 2 (step 2, case 2-1), the UE 120 may transmit the excluded PUCCH resource (PUCCH2) with HARQ-ACK associated with the fixed CORESET pool index value, the multi-slot PUCCH (PUCCH1) with HARQ-ACK associated with the other CORESET pool index value, and the other multi-slot PUCCH resources from step 1 that do not overlap with the excluded PUCCH resource and the other single-slot PUCCH resources from step 1. In some aspects, as described above in connection with the second example for alternate step 2 (step 2, case 2-2), the UE 120 may transmit the multi-slot PUCCH (PUCCH1) with HARQ-ACK associated with the other CORESET pool index value, the other multi-slot PUCCH resources from step 1 that do not overlap with the excluded PUCCH resource (PUCCH2), and the single-slot PUCCH resources after multiplexing the excluded PUCCH resource (PUCCH2) and the single-slot PUCCH resources from step 1.

As described herein, the existing UCI multiplexing and prioritization rules in Rel.15/16/17 for overlapping PUCCH associated with multi-slot PUCCH resources do not account for simultaneous PUCCH transmissions. For example, the existing UCI multiplexing and prioritization rules in Rel.15/16/17 do not specify which UCIs are to be multiplexed or prioritized for simultaneous PUCCH transmissions associated with multi-slot PUCCH resources. This may lead to an increase in error cases, such as missed UCI transmissions or a transmission of low priority UCI over high priority UCI, when simultaneous PUCCH transmissions are scheduled to occur in the multi-slot PUCCH resources. Using the techniques and apparatuses described herein, the UE 120 may be configured with a set of UCI multiplexing and prioritization rules that enable simultaneous PUCCH transmissions for overlapping PUCCH resources associated with multi-slot PUCCH resources. The UE 120 may perform the simultaneous PUCCH transmissions in accordance with the set of UCI multiplexing and prioritization rules, thereby reducing the number of error cases and improving the reliability of the transmissions.

As indicated above, FIG. 7 is provided as an example. Other examples may differ from what is described with regard to FIG. 7.

FIGS. 8A-8C are diagrams illustrating examples 800 and 810 of resolving overlapping PUCCH transmissions, in accordance with the present disclosure.

As shown in the example 800, PUCCH1 may be associated with UCI1 that includes a HARQ-ACK (HARQ-ACK1). PUCCH1 may be a multi-slot PUCCH resource that is associated with a first CORESET pool index value (CORESET pool index value 0). PUCCH2 may be associated with UCI2 that includes a HARQ-ACK (HARQ-ACK2). PUCCH2 may be a multi-slot PUCCH resource that is associated with a second CORESET pool index value (CORESET pool index value 1). PUCCH3 may be associated with a UCI3 that includes a CSI (CSI1). PUCCH3 may be a single-slot PUCCH resource. PUCCH4 may be associated with a UCI4 that includes a CSI (CSI2). PUCCH4 may be a single-slot PUCCH resource. PUCCH5 may be associated with a UCI5 that includes a CSI (CSI3). PUCCH5 may be a single-slot PUCCH resource. PUCCH6 may be associated with a UCI6 that includes a CSI (CSI4). PUCCH6 may be a single-slot PUCCH resource. In step 1, the UE 120 may exclude PUCCH2 from the multiplexing and prioritization. The UE 120 may resolve the overlap between the PUCCH1 and the single-slot PUCCH resources that overlap with PUCCH1. In this case, the UE 120 may drop PUCCH3 and PUCCH5 since PUCCH3 and PUCCH5 overlap with PUCCH1 and have lower priority than PUCCH1. For example, both PUCCH3 and PUCCH5 are associated with CSI, whereas PUCCH1 is associated with a HARQ-ACK which has a higher priority than CSI. In step 2 (case 1-1), the UE 120 may exclude PUCCH1 from the multiplexing and prioritization. The UE 120 may resolve the overlap between PUCCH2 and the remaining single-slot PUCCH resources that overlap with PUCCH2. In this case, the UE 120 may drop PUCCH4 and PUCCH6 since PUCCH4 and PUCCH6 overlap with PUCCH2 and have lower priority than PUCCH2. For example, both PUCCH4 and PUCCH6 are associated with CSI, whereas PUCCH2 is associated with a HARQ-ACK which has a higher priority than CSI. After resolving the overlapping, the UE 120 may transmit PUCCH1 and PUCCH2 simultaneously in the slot.

As shown in the example 810 (in FIG. 8B), PUCCH1 may be associated with UCI1 that includes a HARQ-ACK (HARQ-ACK1). PUCCH1 may be a multi-slot PUCCH resource that is associated with a first CORESET pool index value (CORESET pool index value 0). PUCCH2 may be associated with UCI2 that includes a HARQ-ACK (HARQ-ACK2). PUCCH2 may be a single-slot PUCCH resource that is associated with a second CORESET pool index value (CORESET pool index value 1). PUCCH3 may be associated with a UCI3 that includes a CSI (CSI1). PUCCH3 may be a single-slot PUCCH resource. PUCCH4 may be associated with a UCI4 that includes a CSI (CSI2). PUCCH4 may be a multi-slot PUCCH resource. PUCCH5 may be associated with a UCI5 that includes a CSI (CSI3). PUCCH5 may be a single-slot PUCCH resource. PUCCH6 may be associated with a UCI6 that includes a CSI (CSI4). PUCCH6 may be a single-slot PUCCH resource. PUCCH7 may be associated with a UCI7 that includes a CSI (CSI5) where CSI5 may have higher priority than CSI2. PUCCH7 may be a single-slot PUCCH resource. In step 1, the UE 120 may exclude PUCCH2 from the multiplexing and prioritization. The UE 120 may resolve the overlap between PUCCH1 and the PUCCH resources that overlap with PUCCH1. In this case, the UE 120 may drop PUCCH3 and PUCCH6 since PUCCH3 and PUCCH6 overlap with PUCCH1 and have lower priority than PUCCH1. For example, both PUCCH3 and PUCCH6 are associated with CSI, whereas PUCCH1 is associated with a HARQ-ACK which has a higher priority than CSI. Additionally, the UE 120 may resolve the overlap between PUCCH4 and PUCCH 7 since PUCCH4 is a multi-slot PUCCH. In this case, the UE 120 may drop PUCCH7 since PUCCH4 has higher priority than PUCCH7. In step 2, the UE 120 may exclude PUCCH1 from the multiplexing and prioritization. The UE 120 may resolve the overlap between the PUCCH2 and the multi-slot PUCCH resources that overlap with PUCCH2. In this case, the UE 120 may drop PUCCH4 in slot 1 since PUCCH4 overlaps with PUCCH2 and since PUCCH2 has a higher priority than PUCCH4. However, PUCCH4 may still be transmitted in slot 2. In step 2, case 2-2, the UE 120 may resolve the overlap between PUCCH2 and PUCCH5 in slot 1. In one example as shown in the example 810 (in FIG. 8C), the UE 120 may drop PUCCH5 since PUCCH5 overlaps with PUCCH2 and since PUCCH2 has a higher priority than PUCCH5. PUCCH1 and PUCCH2 may both be transmitted in slot 1, despite the overlap between PUCCH1 and PUCCH2, since PUCCH1 (associated with CORESET pool index value 0) and PUCCH 2 (associated with CORESET pool index value 1) are associated with different CORESET pool index values. In another example as shown in the example 810 (in FIG. 8C), the UE 120 may multiplex PUCCH2 and PUCCH5 to generate a PUCCH8. PUCCH8 may include both UCI2 (associated with PUCCH2) and UCI5 (associated with PUCCH5). PUCCH1 and PUCCH8 may both be transmitted in slot 1, despite the overlap between PUCCH1 and PUCCH8, since PUCCH1 and PUCCH 8 are associated with different CORESET pool index values. PUCCH1 and PUCCH4 may both be transmitted in slot 2 since PUCCH1 and PUCCH4 do not overlap in slot 2.

As indicated above, FIGS. 8A-8C are provided as examples. Other examples may differ from what is described with regard to FIGS. 8A-8C.

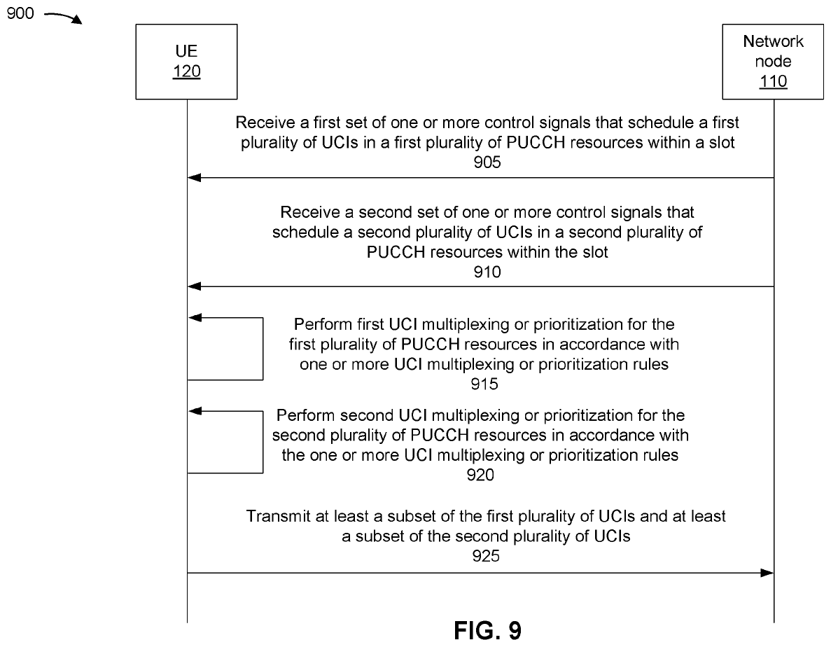

FIG. 9 is a diagram illustrating an example 900 of simultaneous PUCCH transmissions, in accordance with the present disclosure. The UE 120 may communicate with the network node 110. In the example 900, PUCCH resources with CSI or SR information may be associated with a CORESET pool index value. Thus, simultaneous PUCCH transmissions may be possible when the PUCCH resources include a HARQ-ACK, CSI, and/or SR associated with a corresponding CORESET pool index value.

As shown in connection with reference number 905, the UE 120 may receive a first set of one or more control signals that schedule a first plurality of UCIs in a first plurality of PUCCH resources (PUCCH set 1) within a slot. For example, the network node 110 may transmit, and the UE 120 may receive, the first set of the one or more control signals that schedule the first plurality of UCIs in the first plurality of PUCCH resources within the slot. The first plurality of UCIs may include at least one of HARQ feedback information, CSI, or SR information. Each PUCCH resource of the first plurality of PUCCH resources (PUCCH set 1) may be associated with a first control resource set pool index value (e.g., CORESET pool index value 0).

As shown in connection with reference number 910, the UE 120 may receive a second set of one or more control signals that schedule a second plurality of UCIs in a second plurality of PUCCH resources (PUCCH set 2) within the slot. For example, the network node 110 may transmit, and the UE 120 may receive, the second set of one or more control signals that schedule the second plurality of UCIs in the second plurality of PUCCH resources within the slot. The second plurality of UCIs may include at least one of HARQ feedback information, CSI, or SR information. Each PUCCH resource of the second plurality of PUCCH resources (PUCCH set 2) may be associated with a second control resource set pool index value (e.g., CORESET pool index value 1). At least one of the first plurality of PUCCH resources and the second plurality of PUCCH resources may be a multi-slot PUCCH resource.

As shown in connection with reference number 915, the UE 120 may perform first UCI multiplexing or prioritization for the first plurality of PUCCH resources in accordance with the UCI multiplexing or prioritization rules. The first UCI multiplexing or prioritization may result in a first set of one or more non-overlapping PUCCH resources. As shown in connection with reference number 920, the UE 120 may perform second UCI multiplexing or prioritization for the second plurality of PUCCH resources in accordance with the one or more UCI multiplexing or prioritization rules. The second UCI multiplexing or prioritization may result in a second set of one or more non-overlapping PUCCH resources.

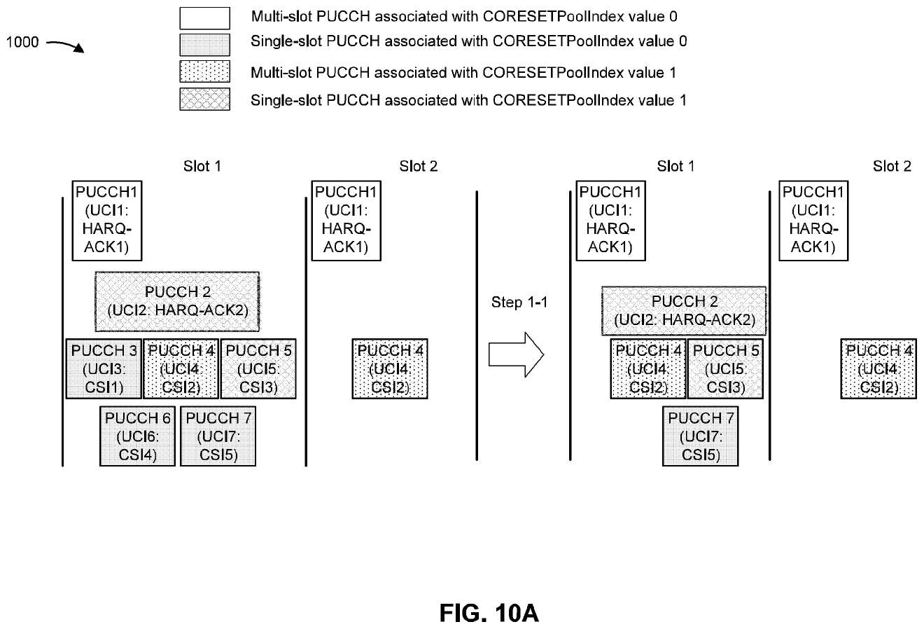

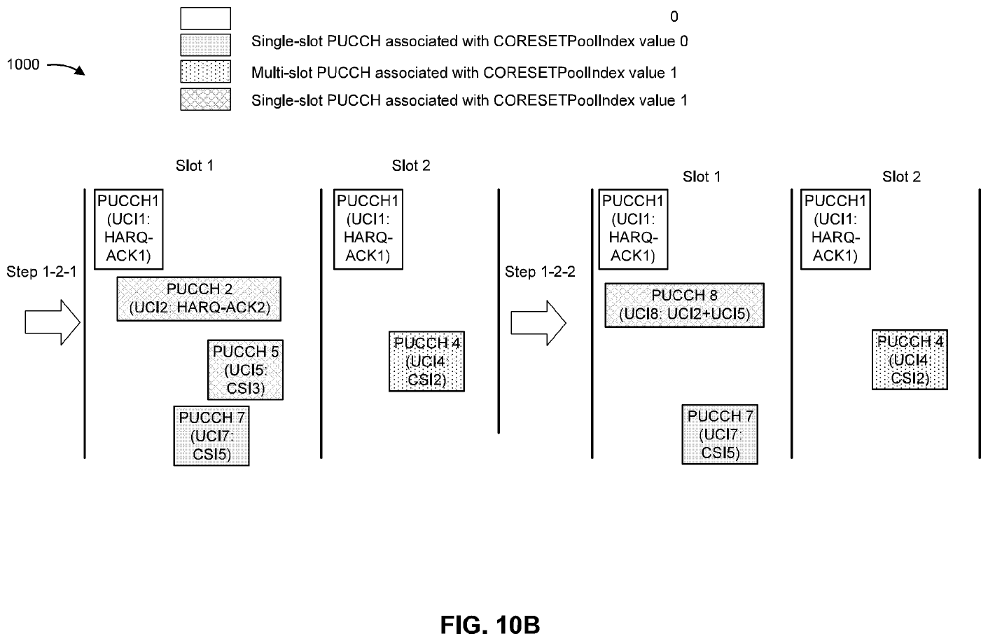

In some aspects, the UE 120 may be configured for simultaneous PUCCH transmissions based at least in part on two (or more) CORESET pool index values being configured for the UE 120, and based at least in part on separate HARQ feedback modes being configured (e.g., “ackNackFeedbackMode=separate”) for the UE 120. In a first example step (step 1), the UE 120 may group the PUCCH resources into the two groups (e.g., PUCCH set 1 and PUCCH set 2) based at least in part on the CORESET pool index values associated with the respective groups. For example, the UE 120 may group the first plurality of PUCCH resources based at least in part on the first plurality of PUCCH resources being associated with CORESET pool index value 0, and may group the second plurality of PUCCH resources based at least in part on the second plurality of PUCCH resources being associated with CORESET pool index value 1. The UE 120 may resolve the overlap, by performing multiplexing and/or prioritization using the set of multiplexing and prioritization rules, separately for each group. Additional details regarding these features are described below and in connection with FIGS. 10A-10B.

In a first example sub step (step 1-1), the UE 120 may resolve the overlap (e.g., perform the multiplexing and/or prioritization) for the PUCCH resources of the first plurality of PUCCH resources (PUCCH set 1) associated with the first CORESET pool index value (e.g., value 0). This results in the first set of non-overlapping PUCCH resources associated with the first CORESET pool index value. In some cases, the UE 120 may first resolve the overlap for the multi-slot PUCCH resources of the first plurality of PUCCH resources (e.g., step 1-1-1) and may thereafter resolve the overlapping for the resultant single-slot PUCCH resources of the first plurality of PUCCH resources if there is any overlapping among the resultant single-slot PUCCH resources (e.g., step 1-1-2).

In a second example sub step (step 1-2), the UE 120 may resolve the overlap (e.g., perform the multiplexing and/or prioritization) for the PUCCH resources of the second plurality of PUCCH resources (PUCCH set 2) associated with the second CORESET pool index value (e.g., value 1). This results in the second set of non-overlapping PUCCH resources associated with the second CORESET pool index value. In some cases, the UE 120 may first resolve the overlapping for the multi-slot PUCCH resources of the second plurality of PUCCH resources (e.g., step 1-2-1) and may thereafter resolve the overlapping for the resultant single-slot PUCCH resources of the second plurality of PUCCH resources if there is any overlapping among the resultant single-slot PUCCH resources (e.g., step 1-2-2).

As shown in connection with reference number 925, the UE 120 may transmit at least a subset of the first plurality of UCIs on the first one or more non-overlapping PUCCH resources and at least a subset of the second plurality of UCIs on the second one or more non-overlapping PUCCH resources. For example, in a second example step (step 2), the UE 120 may transmit the resultant first set of non-overlapping PUCCH resources (from the PUCCH set 1) and the resultant second set of non-overlapping PUCCH resources (from the PUCCH set 2). The UE 120 may transmit the first set of non-overlapping PUCCH resources and the second set of non-overlapping PUCCH resources even if one or more of the PUCCH resources in the first set of non-overlapping PUCCH resources overlaps with one or more of the PUCCH resources in the second set of non-overlapping PUCCH resources.

As indicated above, FIG. 9 is provided as an example. Other examples may differ from what is described with regard to FIG. 9.

FIGS. 10A-10B are diagrams illustrating an example 1000 of resolving overlapping PUCCH transmissions, in accordance with the present disclosure.

As shown in the example 1000, PUCCH1 may be associated with UCI1 that includes a HARQ-ACK (HARQ-ACK1). PUCCH1 may be a multi-slot PUCCH resource that is associated with a first CORESET pool index value (CORESET pool index value 0). PUCCH2 may be associated with UCI2 that includes a HARQ-ACK (HARQ-ACK2). PUCCH2 may be a single-slot PUCCH resource that is associated with a second CORESET pool index value (CORESET pool index value 1). PUCCH3 may be associated with a UCI3 that includes a CSI (CSI1). PUCCH3 may be a single-slot PUCCH resource that is associated with the first CORESET pool index value. PUCCH4 may be associated with a UCI4 that includes a CSI (CSI2). PUCCH4 may be a multi-slot PUCCH resource that is associated with the second CORESET pool index value. PUCCH5 may be associated with a UCI5 that includes a CSI (CSI3). PUCCH5 may be a single-slot PUCCH resource that is associated with the second CORESET pool index value. PUCCH6 may be associated with a UCI6 that includes a CSI (CSI4). PUCCH6 may be a single-slot PUCCH resource that is associated with the first CORESET pool index value. PUCCH7 may be associated with a UCI7 that includes a CSI (CSI5). PUCCH7 may be a single-slot PUCCH resource that is associated with the first CORESET pool index value.

In some aspects, the UE 120 may group the PUCCH resources into a first group of PUCCH resources (PUCCH set 1) that are associated with the first CORESET pool index value (CORESET pool index value 0) and a second group of PUCCH resources (PUCCH set 2) that are associated with the second CORESET pool index value (CORESET pool index value 1). In step 1-1 as shown in example 1000 (in FIG. 10A), the UE 120 may resolve overlaps in the first group of PUCCH resources. The UE 120 may first resolve overlaps associated with the multi-slot PUCCH resources in the first group of PUCCH resources (PUCCH set 1). The UE 120 may drop PUCCH3 and PUCCH6 since PUCCH3 and PUCCH6 overlap with PUCCH1 (which is a multi-slot PUCCH resource), have the same CORESET pool index value as PUCCH1, and have lower priority than PUCCH1. The UE 120 may next resolve overlaps associated with the remaining single-slot PUCCH resources in the first group of PUCCH resources. In this case, there are no remaining overlapping single-slot PUCCH resources in the first group of PUCCH resources. In step 1-2 as shown in example 1000 (in FIG. 10B), the UE 120 may resolve overlaps in the second group of PUCCH resources. The UE 120 may first (e.g., in step 1-2-1) resolve overlaps associated with the multi-slot PUCCH resources in the second set of PUCCH resources (PUCCH set 2). In this case, the UE 120 may drop PUCCH4 in slot 1 since PUCCH4 (which is a multi-slot PUCCH resource) overlaps with PUCCH2, has the same CORESET pool index value as PUCCH2, and has a lower priority than PUCCH2. The UE 120 may next (e.g., in step 1-2-2) resolve overlaps associated with the single-slot PUCCH resources in the second group of PUCCH resources. In this case, the UE 120 may multiplex PUCCH2 and PUCCH5 to generate a PUCCH8. PUCCH8 may include both UCI2 (associated with PUCCH2) and UCI5 (associated with PUCCH5). In some cases, step 1-1 and step 1-2 may be performed in parallel. After step 1-1 and step 1-2, PUCCH1, PUCCH7, and PUCCH8 may all be transmitted in slot 1, since PUCCH1 and PUCCH7 have the same CORESET pool index value but do not overlap with each other, and since PUCCH8 has a different CORESET pool index value than PUCCH1 and PUCCH7.

As indicated above, FIGS. 10A-10B are provided as examples. Other examples may differ from what is described with regard to FIGS. 10A-10B.

FIG. 11 is a diagram illustrating an example process 1100 performed, for example, by a UE, in accordance with the present disclosure. Example process 1100 is an example where the UE (e.g., UE 120) performs operations associated with simultaneous PUCCH transmissions.

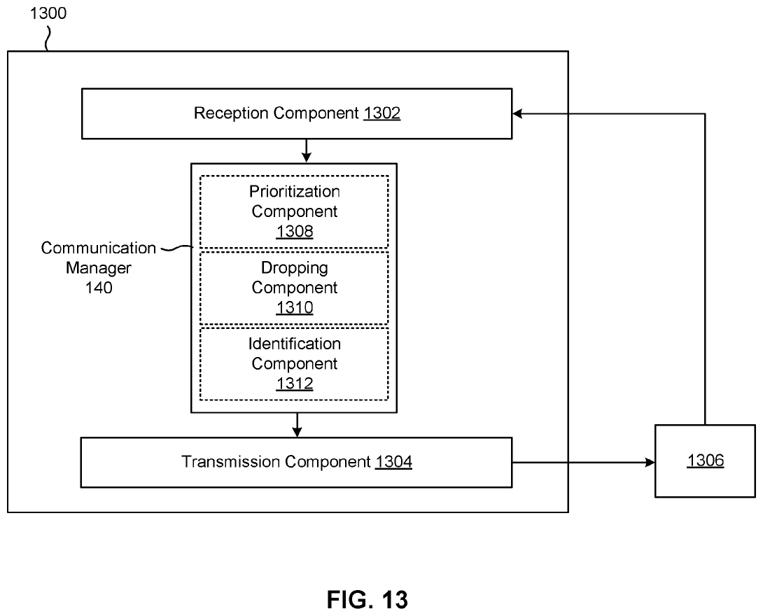

As shown in FIG. 11, in some aspects, process 1100 may include receiving a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource (block 1110). For example, the UE (e.g., using communication manager 140 and/or reception component 1302, depicted in FIG. 13) may receive a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource, as described above.

As further shown in FIG. 11, in some aspects, process 1100 may include receiving control signals that schedule transmissions of one or more other UCIs on a set of PUCCH resources in the slot, the one or more other UCIs comprising channel state information or scheduling request information (block 1120). For example, the UE (e.g., using communication manager 140 and/or reception component 1302, depicted in FIG. 13) may receive control signals that schedule a transmission of one or more other UCIs on a set of PUCCH resources in the slot, the one or more other UCIs comprising channel state information or scheduling request information, as described above.

As further shown in FIG. 11, in some aspects, process 1100 may include performing UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources (block 1130). For example, the UE (e.g., using communication manager 140 and/or prioritization component 1308, depicted in FIG. 13) may perform UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources, as described above.

As further shown in FIG. 11, in some aspects, process 1100 may include transmitting at least the first UCI and the second UCI in the slot based at least in part on the prioritization (block 1140). For example, the UE (e.g., using communication manager 140 and/or transmission component 1304, depicted in FIG. 13) may transmit at least the first UCI and the second UCI in the slot based at least in part on the prioritization, as described above.

Process 1100 may include additional aspects, such as any single aspect or any combination of aspects described below and/or in connection with one or more other processes described elsewhere herein.

In a first aspect, process 1100 includes excluding the second PUCCH resource from the UCI prioritization, in accordance with the set of prioritization rules, based at least in part on the second PUCCH resource being associated with a fixed control resource set pool index value, wherein the first PUCCH resource is a multi-slot PUCCH resource.

In a second aspect, alone or in combination with the first aspect, process 1100 includes identifying that the second PUCCH is associated with the fixed control resource set pool index value based at least in part on the second PUCCH resource being a single-slot PUCCH resource.

In a third aspect, alone or in combination with one or more of the first and second aspects, process 1100 includes identifying that the second PUCCH resource is associated with the fixed control resource set pool index value based at least in part on a configuration of the UE or information received by the UE and based at least in part on both the first PUCCH resource and the second PUCCH resource being multi-slot PUCCH resources.

In a fourth aspect, alone or in combination with one or more of the first through third aspects, performing the UCI prioritization comprises performing the UCI prioritization for the first PUCCH resource and the set of PUCCH resources based at least in part on a characteristic of the first PUCCH resource and a characteristic of the set of PUCCH resources.

In a fifth aspect, alone or in combination with one or more of the first through fourth aspects, process 1100 includes dropping at least one of a single-slot PUCCH resource, of the one or more single-slot PUCCH resources, or a multi-slot PUCCH resource, of the one or more multi-slot PUCCH resources, not including the first PUCCH resource, based at least in part on the single-slot PUCCH resource or the multi-slot PUCCH resource overlapping with the second PUCCH resource and based at least in part on the second PUCCH resource being a multi-slot PUCCH resource.

In a sixth aspect, alone or in combination with one or more of the first through fifth aspects, transmitting at least the first UCI and the second UCI in the slot comprises transmitting the first UCI on the first PUCCH resource, the second UCI on the second PUCCH resource, and any single-slot PUCCH resources or multi-slot PUCCH resources that do not overlap with the second PUCCH resource on the set of PUCCH resources based at least in part on any two single-slot PUCCH resources of the single-slot PUCCH resources, that do not overlap with the second PUCCH resource, not overlapping with each other.

In a seventh aspect, alone or in combination with one or more of the first through sixth aspects, process 1100 includes multiplexing two or more single-slot PUCCH resources to generate one or more multiplexed single-slot PUCCH resources, or performing an additional UCI prioritization for the two or more single-slot PUCCH resources, based at least in part on the two or more single-slot PUCCH resources overlapping with each other but not overlapping with the second PUCCH resource.

In an eighth aspect, alone or in combination with one or more of the first through seventh aspects, transmitting at least the first UCI and the second UCI in the slot comprises transmitting the first UCI on the first PUCCH resource, the second UCI on the second PUCCH resource, the one or more multi-slot PUCCH resources on the set of PUCCH resources that do not overlap with the second PUCCH resource, and the one or more multiplexed single-slot PUCCH resources on the set of PUCCH resources.

In a ninth aspect, alone or in combination with one or more of the first through eighth aspects, process 1100 includes multiplex two or more single-slot PUCCH resources to generate one or more multiplexed single-slot PUCCH resources, wherein the one or more multiplexed single-slot PUCCH resources do not overlap with the second PUCCH resource, and the first PUCCH resource and the one or more multi-slot PUCCH resources do not overlap with the second PUCCH resource.

In a tenth aspect, alone or in combination with one or more of the first through ninth aspects, process 1100 includes dropping a multi-slot PUCCH resource, of the one or more of the multi-slot PUCCH resources, not including the first PUCCH resource, based at least in part on the multi-slot PUCCH resource overlapping with the second PUCCH resource and based at least in part on the second PUCCH resource being a single-slot PUCCH resource.

In an eleventh aspect, alone or in combination with one or more of the first through tenth aspects, transmitting at least the first UCI and the second UCI in the slot comprises transmitting the first UCI on the first PUCCH resource, the second UCI on the second PUCCH resource, and any of the multi-slot PUCCH resources that do not overlap with the second PUCCH resource or the one or more single-slot PUCCH resources on the set of PUCCH resources based at least in part on any two PUCCH resources of the second PUCCH resource and the one or more single-slot PUCCH resources not overlapping with each other.

In a twelfth aspect, alone or in combination with one or more of the first through eleventh aspects, process 1100 includes multiplexing the second PUCCH resource and the one or more of the single-slot PUCCH resources to generate one or more multiplexed single-slot PUCCH resource, or performing an additional UCI prioritization for the second PUCCH resource and the single-slot PUCCH resource, based at least in part on the single-slot PUCCH resource overlapping with the second PUCCH resource.

In a thirteenth aspect, alone or in combination with one or more of the first through twelfth aspects, transmitting at least the first UCI and the second UCI in the slot comprises transmitting the first UCI on the first PUCCH resource, any of the multi-slot PUCCH resources that do not overlap with the second PUCCH resource, and the one or more multiplexed single-slot PUCCH resources.

In a fourteenth aspect, alone or in combination with one or more of the first through thirteenth aspects, transmitting at least the first UCI and the second UCI in the slot comprises transmitting the first UCI and the second UCI in the slot based at least in part on a configuration or capability of the UE to support simultaneous uplink control channel transmissions.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with simultaneous PUCCH transmissions.

As shown in FIG. 12, in some aspects, process 1200 may include receiving a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value (block 1210). For example, the UE (e.g., using communication manager 140 and/or reception component 1302, depicted in FIG. 13) may receive a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value, as described above.

As further shown in FIG. 12, in some aspects, process 1200 may include receiving a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource (block 1220). For example, the UE (e.g., using communication manager 140 and/or reception component 1302, depicted in FIG. 13) may receive a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource, as described above.

As further shown in FIG. 12, in some aspects, process 1200 may include performing first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources (block 1230). For example, the UE (e.g., using communication manager 140 and/or prioritization component 1308, depicted in FIG. 13) may perform first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources, as described above.

As further shown in FIG. 12, in some aspects, process 1200 may include performing second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources (block 1240). For example, the UE (e.g., using communication manager 140 and/or prioritization component 1308, depicted in FIG. 13) may perform second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources, as described above.

As further shown in FIG. 12, in some aspects, process 1200 may include transmitting at least a subset of the first plurality of UCIs on the first one or more non-overlapping PUCCH resources and at least a subset of the second plurality of UCIs on the second one or more non-overlapping PUCCH resources (block 1250). For example, the UE (e.g., using communication manager 140 and/or transmission component 1304, depicted in FIG. 13) may transmit at least a subset of the first plurality of UCIs on the first one or more non-overlapping PUCCH resources and at least a subset of the second plurality of UCIs on the second one or more non-overlapping PUCCH resources, as described above.

Process 1200 may include additional aspects, such as any single aspect or any combination of aspects described below and/or in connection with one or more other processes described elsewhere herein.

In a first aspect, performing the first UCI multiplexing or prioritization for the first plurality of PUCCH resources comprises resolving an overlap for two or more overlapping multi-slot PUCCH resources in the first plurality of PUCCH resources.

In a second aspect, alone or in combination with the first aspect, performing the first UCI multiplexing or prioritization for the first plurality of PUCCH resources further comprises resolving an overlap between two or more overlapping single-slot PUCCH resources in the first plurality of PUCCH resources.

In a third aspect, alone or in combination with one or more of the first and second aspects, performing the second UCI multiplexing or prioritization for the second plurality of PUCCH resources comprises resolving an overlap for two or more overlapping multi-slot PUCCH resources in the second plurality of PUCCH resources.

In a fourth aspect, alone or in combination with one or more of the first through third aspects, performing the second UCI multiplexing or prioritization for the second plurality of PUCCH resources further comprises resolving an overlap for two or more overlapping single-slot PUCCH resources in the second plurality of PUCCH resources.

In a fifth aspect, alone or in combination with one or more of the first through fourth aspects, transmitting the subset of the first plurality of UCIs on the first one or more non-overlapping PUCCH resources and the subset of the second plurality of UCIs on the second one or more non-overlapping PUCCH resources comprises transmitting the subset of the first plurality of UCIs on the first one or more non-overlapping PUCCH resources and the subset of the second plurality of UCIs on the second one or more non-overlapping PUCCH resources when a portion of the subset of the first plurality of UCIs being transmitted on the first one or more non-overlapping PUCCH resources overlaps with a portion of the subset of the second plurality of UCIs being transmitted on the second one or more non-overlapping PUCCH resources.

In a sixth aspect, alone or in combination with one or more of the first through fifth aspects, transmitting the subset of the first plurality of UCIs on the first one or more non-overlapping PUCCH resources and the subset of the second plurality of UCIs on the second one or more non-overlapping PUCCH resources comprises transmitting the subset of the first plurality of UCIs on the first one or more non-overlapping PUCCH resources and the subset of the second plurality of UCIs on the second one or more non-overlapping PUCCH resources based at least in part on a configuration or capability of the UE to support simultaneous uplink control channel transmissions.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a prioritization component 1308, a dropping component 1310, or an identification component 1312, among other examples.

In some aspects, the apparatus 1300 may be configured to perform one or more operations described herein in connection with FIGS. 7, 8A-8C, 9, and 10A-10B. Additionally, or alternatively, the apparatus 1300 may be configured to perform one or more processes described herein, such as process 1100 of FIG. 11, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive a first indication to transmit first UCI on a first PUCCH resource in a slot and a second indication to transmit second UCI on a second PUCCH resource in the slot, wherein the first UCI comprises HARQ feedback information associated with a first control resource set pool index value and the second UCI comprises HARQ feedback information associated with a second control resource set pool index value, and wherein at least one of the first PUCCH resource and the second PUCCH resource is a multi-slot PUCCH resource. The reception component 1302 may receive control signals that schedule a transmission of one or more other UCIs on a set of PUCCH resources in the slot, the one or more other UCIs comprising channel state information or scheduling request information. The prioritization component 1308 may perform UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources. The transmission component 1304 may transmit at least the first UCI and the second UCI in the slot based at least in part on the prioritization. The dropping component 1310 may exclude the second PUCCH resource from the UCI prioritization, in accordance with the set of prioritization rules, based at least in part on the second PUCCH resource being associated with a fixed control resource set pool index value, wherein the first PUCCH resource is a multi-slot PUCCH resource.

The identification component 1312 may identify that the second PUCCH is associated with the fixed control resource set pool index value based at least in part on the second PUCCH resource being a single-slot PUCCH resource. The identification component 1312 may identify that the second PUCCH resource is associated with the fixed control resource set pool index value based at least in part on a configuration of the UE or information received by the UE and based at least in part on both the first PUCCH resource and the second PUCCH resource being multi-slot PUCCH resources. The dropping component 1310 may drop at least one of a single-slot PUCCH resource, of the one or more single-slot PUCCH resources, or a multi-slot PUCCH resource, of the one or more multi-slot PUCCH resources, not including the first PUCCH resource, based at least in part on the single-slot PUCCH resource or the multi-slot PUCCH resource overlapping with the second PUCCH resource and based at least in part on the second PUCCH resource being a multi-slot PUCCH resource.

The prioritization component 1308 may multiplex two or more single-slot PUCCH resources to generate one or more multiplexed single-slot PUCCH resources, or perform an additional UCI prioritization for the two or more single-slot PUCCH resources, based at least in part on the two or more single-slot PUCCH resources overlapping with each other but not overlapping with the second PUCCH resource. The prioritization component 1308 may multiplex the first PUCCH resource and a multi-slot PUCCH resource of the one or more multi-slot PUCCH resources based at least in part on the multi-slot PUCCH resource not overlapping with the second PUCCH resource. The dropping component 1310 may drop a multi-slot PUCCH resource, of the one or more of the multi-slot PUCCH resources, not including the first PUCCH resource, based at least in part on the multi-slot PUCCH resource overlapping with the second PUCCH resource and based at least in part on the second PUCCH resource being a single-slot PUCCH resource. The prioritization component 1308 may multiplex the second PUCCH resource and the one or more of the single-slot PUCCH resources to generate one or more multiplexed single-slot PUCCH resource, or perform an additional UCI prioritization for the second PUCCH resource and the single-slot PUCCH resource, based at least in part on the single-slot PUCCH resource overlapping with the second PUCCH resource.

The reception component 1302 may receive a first set of one or more control signals that schedule a first plurality of UCIs in a first plurality of PUCCH resources within a slot, wherein the first plurality of UCIs comprises at least one of HARQ feedback information, channel state information, or scheduling request information, and each PUCCH resource of the first plurality of PUCCH resources is associated with a first control resource set pool index value. The reception component 1302 may receive a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource. The prioritization component 1308 may perform first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources. The prioritization component 1308 may perform second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources. The transmission component 1304 may transmit at least a subset of the first plurality of UCIs on the first one or more non-overlapping PUCCH resources and at least a subset of the second plurality of UCIs on the second one or more non-overlapping PUCCH resources.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a first indication to transmit first uplink control information (UCI) on a first physical uplink control channel (PUCCH) resource in a slot and a second indication to transmit second UCI on a second PUCCH resource in the slot, wherein the first UCI comprises hybrid automatic repeat request (HARQ) feedback information associated with a first control resource set pool index value and the second UCI comprises HARQ feedback information associated with a second control resource set pool index value, and wherein at least one of the first PUCCH resource and the second PUCCH resource is a multi-slot PUCCH resource; receiving control signals that schedule transmissions of one or more other UCIs on a set of PUCCH resources in the slot, the one or more other UCIs comprising channel state information or scheduling request information; performing UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources; and transmitting at least the first UCI and the second UCI in the slot based at least in part on the prioritization.

Aspect 2: The method of Aspect 1, further comprising excluding the second PUCCH resource from the UCI prioritization, in accordance with the set of prioritization rules, based at least in part on the second PUCCH resource being associated with a fixed control resource set pool index value, wherein the first PUCCH resource is a multi-slot PUCCH resource.

Aspect 3: The method of Aspect 2, further comprising identifying that the second PUCCH is associated with the fixed control resource set pool index value based at least in part on the second PUCCH resource being a single-slot PUCCH resource.

Aspect 4: The method of Aspect 2, further comprising identifying that the second PUCCH resource is associated with the fixed control resource set pool index value based at least in part on a configuration of the UE or information received by the UE and based at least in part on both the first PUCCH resource and the second PUCCH resource being multi-slot PUCCH resources.

Aspect 5: The method of Aspect 2, wherein performing the UCI prioritization comprises performing the UCI prioritization for the first PUCCH resource and the set of PUCCH resources based at least in part on a characteristic of the first PUCCH resource and a characteristic of the set of PUCCH resources.

Aspect 6: The method of Aspect 2, further comprising dropping at least one of a single-slot PUCCH resource, of the one or more single-slot PUCCH resources, or a multi-slot PUCCH resource, of the one or more multi-slot PUCCH resources, not including the first PUCCH resource, based at least in part on the single-slot PUCCH resource or the multi-slot PUCCH resource overlapping with the second PUCCH resource and based at least in part on the second PUCCH resource being a multi-slot PUCCH resource.

Aspect 7: The method of Aspect 6, wherein transmitting at least the first UCI and the second UCI in the slot comprises transmitting the first UCI on the first PUCCH resource, the second UCI on the second PUCCH resource, and any single-slot PUCCH resources or multi-slot PUCCH resources that do not overlap with the second PUCCH resource on the set of PUCCH resources based at least in part on any two single-slot PUCCH resources of the single-slot PUCCH resources, that do not overlap with the second PUCCH resource, not overlapping with each other.

Aspect 8: The method of Aspect 6, further comprising multiplexing two or more single-slot PUCCH resources to generate one or more multiplexed single-slot PUCCH resources, or performing an additional UCI prioritization for the two or more single-slot PUCCH resources, based at least in part on the two or more single-slot PUCCH resources overlapping with each other but not overlapping with the second PUCCH resource.

Aspect 9: The method of Aspect 8, wherein transmitting at least the first UCI and the second UCI in the slot comprises transmitting the first UCI on the first PUCCH resource, the second UCI on the second PUCCH resource, the one or more multi-slot PUCCH resources on the set of PUCCH resources that do not overlap with the second PUCCH resource, and the one or more multiplexed single-slot PUCCH resources on the set of PUCCH resources.

Aspect 10: The method of Aspect 8, further comprising multiplexing two or more single-slot PUCCH resources to generate one or more multiplexed single-slot PUCCH resources, wherein the one or more multiplexed single-slot PUCCH resources do not overlap with the second PUCCH resource, and the first PUCCH resource and the one or more multi-slot PUCCH resources do not overlap with the second PUCCH resource.

Aspect 11: The method of Aspect 2, further comprising dropping a multi-slot PUCCH resource, of the one or more of the multi-slot PUCCH resources, not including the first PUCCH resource, based at least in part on the multi-slot PUCCH resource overlapping with the second PUCCH resource and based at least in part on the second PUCCH resource being a single-slot PUCCH resource.

Aspect 12: The method of Aspect 11, wherein transmitting at least the first UCI and the second UCI in the slot comprises transmitting the first UCI on the first PUCCH resource, the second UCI on the second PUCCH resource, and any of the multi-slot PUCCH resources that do not overlap with the second PUCCH resource or the one or more single-slot PUCCH resources on the set of PUCCH resources based at least in part on any two PUCCH resources of the second PUCCH resource and the one or more single-slot PUCCH resources not overlapping with each other.

Aspect 13: The method of Aspect 11, further comprising multiplexing the second PUCCH resource and the one or more of the single-slot PUCCH resources to generate one or more multiplexed single-slot PUCCH resource, or performing an additional UCI prioritization for the second PUCCH resource and the single-slot PUCCH resource, based at least in part on the single-slot PUCCH resource overlapping with the second PUCCH resource.

Aspect 14: The method of Aspect 13, wherein transmitting at least the first UCI and the second UCI in the slot comprises transmitting the first UCI on the first PUCCH resource, any of the multi-slot PUCCH resources that do not overlap with the second PUCCH resource, and the one or more multiplexed single-slot PUCCH resources.

Aspect 15: The method of Aspect 1, wherein transmitting at least the first UCI and the second UCI in the slot comprises transmitting the first UCI and the second UCI in the slot based at least in part on a configuration or capability of the UE to support simultaneous uplink control channel transmissions.

Aspect 16: A method of wireless communication performed by a user equipment (UE), comprising: receiving a first set of one or more control signals that schedule a first plurality of uplink control information (UCIs) in a first plurality of physical uplink control channel (PUCCH) resources within a slot, wherein the first plurality of UCIs comprises at least one of hybrid automatic repeat request (HARQ) feedback information, channel state information, or scheduling request information, and each PUCCH resource of the first plurality of PUCCH resources is associated with a first control resource set pool index value; receiving a second set of one or more control signals that schedule a second plurality of UCIs in a second plurality of PUCCH resources within the slot, wherein the second plurality of UCIs comprises at least one of HARQ feedback information, channel state information, or scheduling request information, and each PUCCH resource of the second plurality of PUCCH resources is associated with a second control resource set pool index value, and wherein at least one of the first plurality of PUCCH resources and the second plurality of PUCCH resources is a multi-slot PUCCH resource; performing first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources; performing second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources; and transmitting at least a subset of the first plurality of UCIs on the first one or more non-overlapping PUCCH resources and at least a subset of the second plurality of UCIs on the second one or more non-overlapping PUCCH resources.

Aspect 17: The method of Aspect 16, wherein performing the first UCI multiplexing or prioritization for the first plurality of PUCCH resources comprises resolving an overlap for two or more overlapping multi-slot PUCCH resources in the first plurality of PUCCH resources.

Aspect 18: The method of Aspect 17, wherein performing the first UCI multiplexing or prioritization for the first plurality of PUCCH resources further comprises resolving an overlap between two or more overlapping single-slot PUCCH resources in the first plurality of PUCCH resources.

Aspect 19: The method of Aspect 18, wherein performing the second UCI multiplexing or prioritization for the second plurality of PUCCH resources comprises resolving an overlap for two or more overlapping multi-slot PUCCH resources in the second plurality of PUCCH resources.

Aspect 20: The method of Aspect 19, wherein performing the second UCI multiplexing or prioritization for the second plurality of PUCCH resources further comprises resolving an overlap for two or more overlapping single-slot PUCCH resources in the second plurality of PUCCH resources.

Aspect 21: The method of Aspect 16, wherein transmitting the subset of the first plurality of UCIs on the first one or more non-overlapping PUCCH resources and the subset of the second plurality of UCIs on the second one or more non-overlapping PUCCH resources comprises transmitting the subset of the first plurality of UCIs on the first one or more non-overlapping PUCCH resources and the subset of the second plurality of UCIs on the second one or more non-overlapping PUCCH resources when a portion of the subset of the first plurality of UCIs being transmitted on the first one or more non-overlapping PUCCH resources overlaps with a portion of the subset of the second plurality of UCIs being transmitted on the second one or more non-overlapping PUCCH resources.

Aspect 22: The method of Aspect 16, wherein transmitting the subset of the first plurality of UCIs on the first one or more non-overlapping PUCCH resources and the subset of the second plurality of UCIs on the second one or more non-overlapping PUCCH resources comprises transmitting the subset of the first plurality of UCIs on the first one or more non-overlapping PUCCH resources and the subset of the second plurality of UCIs on the second one or more non-overlapping PUCCH resources based on a configuration or capability of the UE to support simultaneous uplink control channel transmissions.

Aspect 23: An apparatus for wireless communication at a device, comprising a processor; memory coupled with the processor; and instructions stored in the memory and executable by the processor to cause the apparatus to perform the method of one or more of Aspects 1-15.

Aspect 24: A device for wireless communication, comprising a memory and one or more processors coupled to the memory, the one or more processors configured to perform the method of one or more of Aspects 1-15.

Aspect 25: An apparatus for wireless communication, comprising at least one means for performing the method of one or more of Aspects 1-15.

Aspect 26: A non-transitory computer-readable medium storing code for wireless communication, the code comprising instructions executable by a processor to perform the method of one or more of Aspects 1-15.

Aspect 27: A non-transitory computer-readable medium storing a set of instructions for wireless communication, the set of instructions comprising one or more instructions that, when executed by one or more processors of a device, cause the device to perform the method of one or more of Aspects 1-15.

Aspect 28: An apparatus for wireless communication at a device, comprising a processor; memory coupled with the processor; and instructions stored in the memory and executable by the processor to cause the apparatus to perform the method of one or more of Aspects 16-22.

Aspect 29: A device for wireless communication, comprising a memory and one or more processors coupled to the memory, the one or more processors configured to perform the method of one or more of Aspects 16-22.

Aspect 30: An apparatus for wireless communication, comprising at least one means for performing the method of one or more of Aspects 16-22.

Aspect 31: A non-transitory computer-readable medium storing code for wireless communication, the code comprising instructions executable by a processor to perform the method of one or more of Aspects 16-22.

Aspect 32: A non-transitory computer-readable medium storing a set of instructions for wireless communication, the set of instructions comprising one or more instructions that, when executed by one or more processors of a device, cause the device to perform the method of one or more of Aspects 16-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive a first indication to transmit first uplink control information (UCI) on a first physical uplink control channel (PUCCH) resource in a slot and a second indication to transmit second UCI on a second PUCCH resource in the slot, wherein the first UCI comprises hybrid automatic repeat request (HARQ) feedback information associated with a first control resource set pool index value and the second UCI comprises HARQ feedback information associated with a second control resource set pool index value, and wherein at least one of the first PUCCH resource and the second PUCCH resource is a multi-slot PUCCH resource;
receive control signals that schedule transmissions of one or more other UCIs on a set of PUCCH resources in the slot, the one or more other UCIs comprising channel state information or scheduling request information;
perform UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources; and
transmit at least the first UCI and the second UCI in the slot based at least in part on the prioritization.

2. The apparatus of claim 1, wherein the one or more processors are further configured to exclude the second PUCCH resource from the UCI prioritization, in accordance with the set of prioritization rules, based at least in part on the second PUCCH resource being associated with a fixed control resource set pool index value, wherein the first PUCCH resource is a multi-slot PUCCH resource.

3. The apparatus of claim 2, wherein the one or more processors are further configured to identify that the second PUCCH is associated with the fixed control resource set pool index value based at least in part on the second PUCCH resource being a single-slot PUCCH resource.

4. The apparatus of claim 2, wherein the one or more processors are further configured to identify that the second PUCCH resource is associated with the fixed control resource set pool index value based at least in part on a configuration of the UE or information received by the UE and based at least in part on both the first PUCCH resource and the second PUCCH resource being multi-slot PUCCH resources.

5. The apparatus of claim 2, wherein the one or more processors, to perform the UCI prioritization, are configured to perform the UCI prioritization for the first PUCCH resource and the set of PUCCH resources based at least in part on a characteristic of the first PUCCH resource and a characteristic of the set of PUCCH resources.

6. The apparatus of claim 2, wherein the one or more processors are further configured to drop at least one of a single-slot PUCCH resource, of the one or more single-slot PUCCH resources, or a multi-slot PUCCH resource, of the one or more multi-slot PUCCH resources, not including the first PUCCH resource, based at least in part on the single-slot PUCCH resource or the multi-slot PUCCH resource overlapping with the second PUCCH resource and based at least in part on the second PUCCH resource being a multi-slot PUCCH resource.

7. The apparatus of claim 6, wherein the one or more processors, to transmit at least the first UCI and the second UCI in the slot, are configured to transmit the first UCI on the first PUCCH resource, the second UCI on the second PUCCH resource, and any single-slot PUCCH resources or multi-slot PUCCH resources that do not overlap with the second PUCCH resource on the set of PUCCH resources based at least in part on any two single-slot PUCCH resources of the single-slot PUCCH resources, that do not overlap with the second PUCCH resource, not overlapping with each other.

8. The apparatus of claim 6, wherein the one or more processors are further configured to multiplex two or more single-slot PUCCH resources to generate one or more multiplexed single-slot PUCCH resources, or perform an additional UCI prioritization for the two or more single-slot PUCCH resources, based at least in part on the two or more single-slot PUCCH resources overlapping with each other but not overlapping with the second PUCCH resource.

9. The apparatus of claim 8, wherein the one or more processors, to transmit at least the first UCI and the second UCI in the slot, are configured to transmit the first UCI on the first PUCCH resource, the second UCI on the second PUCCH resource, the one or more multi-slot PUCCH resources on the set of PUCCH resources that do not overlap with the second PUCCH resource, and the one or more multiplexed single-slot PUCCH resource on the set of PUCCH resources.

10. The apparatus of claim 8, wherein the one or more processors are further configured to multiplex two or more single-slot PUCCH resources to generate one or more multiplexed single-slot PUCCH resources, wherein the one or more multiplexed single-slot PUCCH resources do not overlap with the second PUCCH resource, and the first PUCCH resource and the one or more multi-slot PUCCH resources do not overlap with the second PUCCH resource.

11. The apparatus of claim 2, wherein the one or more processors are further configured to drop a multi-slot PUCCH resource, of the one or more of the multi-slot PUCCH resources, not including the first PUCCH resource, based at least in part on the multi-slot PUCCH resource overlapping with the second PUCCH resource and based at least in part on the second PUCCH resource being a single-slot PUCCH resource.

12. The apparatus of claim 11, wherein the one or more processors, to transmit at least the first UCI and the second UCI in the slot, are configured to transmit the first UCI on the first PUCCH resource, the second UCI on the second PUCCH resource, and any of the multi-slot PUCCH resources that do not overlap with the second PUCCH resource or the one or more single-slot PUCCH resources on the set of PUCCH resources based at least in part on any two PUCCH resources of the second PUCCH resource and the one or more single-slot PUCCH resources not overlapping with each other.

13. The apparatus of claim 11, wherein the one or more processors are further configured to multiplex the second PUCCH resource and the one or more of the single-slot PUCCH resources to generate one or more multiplexed single-slot PUCCH resource, or perform an additional UCI prioritization for the second PUCCH resource and the single-slot PUCCH resource, based at least in part on the single-slot PUCCH resource overlapping with the second PUCCH resource.

14. The apparatus of claim 13, wherein the one or more processors, to transmit at least the first UCI and the second UCI in the slot, are configured to transmit the first UCI on the first PUCCH resource, any of the multi-slot PUCCH resources that do not overlap with the second PUCCH resource, and the one or more multiplexed single-slot PUCCH resources.

15. An apparatus for wireless communication at a user equipment (UE), comprising:
a memory; and
one or more processors, coupled to the memory, configured to:
receive a first set of one or more control signals that schedule a first plurality of uplink control information (UCIs) in a first plurality of physical uplink control channel (PUCCH) resources within a slot, wherein the first plurality of UCIs comprises at least one of hybrid automatic repeat request (HARQ) feedback information, channel state information, or scheduling request information and each PUCCH resource of the first plurality of PUCCH resources is associated with a first control resource set pool index value;
receive a second set of one or more control signals that schedule a second plurality of UCIs in a second plurality of PUCCH resources within the slot, wherein the second plurality of UCIs comprises at least one of HARQ feedback information, channel state information, or scheduling request information and each PUCCH resource of the second plurality of PUCCH resources is associated with a second control resource set pool index value, and wherein at least one of the first plurality of PUCCH resources and the second plurality of PUCCH resources is a multi-slot PUCCH resource;
perform first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources;
perform second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources; and
transmit at least a subset of the first plurality of UCIs on the first one or more non-overlapping PUCCH resources and at least a subset of the second plurality of UCIs on the second one or more non-overlapping PUCCH resources.

16. The apparatus of claim 15, wherein the one or more processors, to perform the first UCI multiplexing or prioritization for the first plurality of PUCCH resources, are configured to:
resolve an overlap for two or more overlapping multi-slot PUCCH resources in the first plurality of PUCCH resources; and
resolve an overlap for two or more overlapping single-slot PUCCH resources in the first plurality of PUCCH resources based at least in part on resolving the overlap for the two or more overlapping multi-slot PUCCH resources in the first plurality of PUCCH resources.

17. The apparatus of claim 16, wherein the one or more processors, to perform the second UCI multiplexing or prioritization for the second plurality of PUCCH resources, are configured to:
resolve an overlap for two or more overlapping multi-slot PUCCH resources in the second plurality of PUCCH resources; and
resolve an overlap for two or more overlapping single-slot PUCCH resources in the second plurality of PUCCH resources based at least in part on resolving the overlap for the two or more overlapping multi-slot PUCCH resources in the second plurality of PUCCH resources.

18. The apparatus of claim 15, wherein the one or more processors, to transmit the subset of the first plurality of UCIs on the first one or more non-overlapping PUCCH resources and the subset of the second plurality of UCIs on the second one or more non-overlapping PUCCH resources, are configured to transmit the subset of the first plurality of UCIs on the first one or more non-overlapping PUCCH resources and the subset of the second plurality of UCIs on the second one or more non-overlapping PUCCH resources when a portion of the subset of the first plurality of UCIs being transmitted on the first one or more non-overlapping PUCCH resources overlaps with a portion of the subset of the second plurality of UCIs being transmitted on the second one or more non-overlapping PUCCH resources.

19. A method of wireless communication performed by a user equipment (UE), comprising:
receiving a first indication to transmit first uplink control information (UCI) on a first physical uplink control channel (PUCCH) resource in a slot and a second indication to transmit second UCI on a second PUCCH resource in the slot, wherein the first UCI comprises hybrid automatic repeat request (HARQ) feedback information associated with a first control resource set pool index value and the second UCI comprises HARQ feedback information associated with a second control resource set pool index value, and wherein at least one of the first PUCCH resource and the second PUCCH resource is a multi-slot PUCCH resource;
receiving control signals that schedule a transmission of one or more other UCIs on a set of PUCCH resources in the slot, the one or more other UCIs comprising channel state information or scheduling request information;
performing UCI prioritization for the first PUCCH resource and the set of PUCCH resources in accordance with a set of prioritization rules, wherein the UCI prioritization results in one or more non-overlapping multi-slot PUCCH resources and one or more single-slot PUCCH resources that do not overlap with any of the one or more multi-slot PUCCH resources; and
transmitting at least the first UCI and the second UCI in the slot based at least in part on the prioritization.

20. The method of claim 19, further comprising excluding the second PUCCH resource from the UCI prioritization, in accordance with the set of prioritization rules, based at least in part on the second PUCCH resource being associated with a fixed control resource set pool index value, wherein the first PUCCH resource is a multi-slot PUCCH resource.

21. The method of claim 20, further comprising identifying that the second PUCCH is associated with the fixed control resource set pool index value based at least in part on the second PUCCH resource being a single-slot PUCCH resource.

22. The method of claim 20, further comprising identifying that the second PUCCH resource is associated with the fixed control resource set pool index value based at least in part on a configuration of the UE or information received by the UE and based at least in part on both the first PUCCH resource and the second PUCCH resource being multi-slot PUCCH resources.

23. The method of claim 20, further comprising dropping at least one of a single-slot PUCCH resource, of the one or more single-slot PUCCH resources, or a multi-slot PUCCH resource, of the one or more multi-slot PUCCH resources, not including the first PUCCH resource, based at least in part on the single-slot PUCCH resource or the multi-slot PUCCH resource overlapping with the second PUCCH resource and based at least in part on the second PUCCH resource being a multi-slot PUCCH resource, wherein transmitting at least the first UCI and the second UCI in the slot comprises transmitting the first UCI on the first PUCCH resource, the second UCI on the second PUCCH resource, and any single-slot PUCCH resources or multi-slot PUCCH resources that do not overlap with the second PUCCH resource on the set of PUCCH resources based at least in part on any two PUCCH resources of the single-slot PUCCH resources not overlapping with the second PUCCH resource not overlapping with each other.

24. The method of claim 23, further comprising multiplexing two or more single-slot PUCCH resources to generate one or more multiplexed single-slot PUCCH resources, or performing an additional UCI prioritization for the two or more single-slot PUCCH resources, based at least in part on the two or more single-slot PUCCH resources overlapping with each other but not overlapping with the second PUCCH resource, wherein transmitting at least the first UCI and the second UCI in the slot comprises transmitting the first UCI on the first PUCCH resource, the second UCI on the second PUCCH resource, the one or more multi-slot PUCCH resources on the set of PUCCH resources that do not overlap with the second PUCCH resource, and the one or more multiplexed single-slot PUCCH resource on the set of PUCCH resources.

25. The method of claim 20, further comprising dropping a multi-slot PUCCH resource, of the one or more of the multi-slot PUCCH resources, not including the first PUCCH resource, based at least in part on the multi-slot PUCCH resource overlapping with the second PUCCH resource and based at least in part on the second PUCCH resource being a single-slot PUCCH resource, wherein transmitting at least the first UCI and the second UCI in the slot comprises transmitting the first UCI on the first PUCCH resource, the second UCI on the second PUCCH resource, and any of the multi-slot PUCCH resources that do not overlap with the second PUCCH resource or the one or more single-slot PUCCH resources on the set of PUCCH resources based at least in part on any two PUCCH resources of the second PUCCH resource and the one or more single-slot PUCCH resources not overlapping with each other.

26. The method of claim 25, further comprising multiplexing the second PUCCH resource and the one or more of the single-slot PUCCH resources to generate one or more multiplexed single-slot PUCCH resource, or performing an additional UCI prioritization for the second PUCCH resource and the single-slot PUCCH resource, based at least in part on the single-slot PUCCH resource overlapping with the second PUCCH resource, wherein transmitting at least the first UCI and the second UCI in the slot comprises transmitting the first UCI on the first PUCCH resource, any of the multi-slot PUCCH resources that do not overlap with the second PUCCH resource, and the one or more multiplexed single-slot PUCCH resources.

27. A method of wireless communication performed by a user equipment (UE), comprising:
receiving a first set of one or more control signals that schedule a first plurality of UCIs in a first plurality of PUCCH resources within a slot, wherein the first plurality of UCIs comprises at least one of HARQ feedback information, channel state information, or scheduling request information and each PUCCH resource of the first plurality of PUCCH resources is associated with a first control resource set pool index value;
receiving a second set of one or more control signals that schedule a second plurality of UCIs in a second plurality of PUCCH resources within the slot, wherein the second plurality of UCIs comprises at least one of HARQ feedback information, channel state information, or scheduling request information and each PUCCH resource of the second plurality of PUCCH resources is associated with a second control resource set pool index value, and wherein at least one of the first plurality of PUCCH resources and the second plurality of PUCCH resources is a multi-slot PUCCH resource;
performing first UCI multiplexing or prioritization for the first plurality of PUCCH resources in accordance with one or more UCI multiplexing or prioritization rules, wherein the first UCI multiplexing or prioritization results in a first one or more non-overlapping PUCCH resources;
performing second UCI multiplexing or prioritization for the second plurality of PUCCH resources in accordance with the one or more UCI multiplexing or prioritization rules, wherein the second UCI multiplexing or prioritization results in a second one or more non-overlapping PUCCH resources; and
transmitting at least a subset of the first plurality of UCIs on the first one or more non-overlapping PUCCH resources and at least a subset of the second plurality of UCIs on the second one or more non-overlapping PUCCH resources.

28. The method of claim 27, wherein performing the first UCI multiplexing or prioritization for the first plurality of PUCCH resources comprises:
resolving an overlap for two or more overlapping multi-slot PUCCH resources in the first plurality of PUCCH resources; and
resolving an overlap for two or more overlapping single-slot PUCCH resources in the first plurality of PUCCH resources based at least in part on resolving the overlap for the two or more overlapping multi-slot PUCCH resources in the first plurality of PUCCH resources.

29. The method of claim 28, wherein performing the second UCI multiplexing or prioritization for the second plurality of PUCCH resources comprises:
resolving an overlap for two or more overlapping multi-slot PUCCH resources in the second plurality of PUCCH resources; and
resolving an overlap for two or more overlapping single-slot PUCCH resources in the second plurality of PUCCH resources based at least in part on resolving the overlap for the two or more overlapping multi-slot PUCCH resources in the second plurality of PUCCH resources.

30. The method of claim 27, wherein transmitting the subset of the first plurality of UCIs on the first one or more non-overlapping PUCCH resources and the subset of the second plurality of UCIs on the second one or more non-overlapping PUCCH resources comprises transmitting the subset of the first plurality of UCIs on the first one or more non-overlapping PUCCH resources and the subset of the second plurality of UCIs on the second one or more non-overlapping PUCCH resources when a portion of the subset of the first plurality of UCIs being transmitted on the first one or more non-overlapping PUCCH resources overlaps with a portion of the subset of the second plurality of UCIs being transmitted on the second one or more non-overlapping PUCCH resources.
